(19) United States
(12) Patent Application Publication
(10) Pub. No.: US 2023/0011643 A1
(43) Pub. Date: Jan. 12, 2023

(54) ATTORNEYS RANKING BASED ON THEIR HISTORIC WORK-RELATED PERFORMANCE

(71) Applicant: SHAKEEL MUSTAFA, LIVERMORE, CA (US)

(72) Inventor: SHAKEEL MUSTAFA, LIVERMORE, CA (US)

(21) Appl. No.: 17/849,860

(22) Filed: Jun. 27, 2022

Related U.S. Application Data
(60) Provisional application No. 63/215,617, filed on Jun. 28, 2021.

(51) Int. Cl. G06Q 10/06; G06F 16/901

(52) U.S. Cl. CPC G06Q 10/06398; G06F 16/9024; G06Q 50/18

(57) ABSTRACT

Systems and methods are disclosed for attorney ranking based on historic work and past performance. In an embodiment, the method includes generating data for evaluating the legal experience of legal personnel that includes populating a user interface with data about the past case history of at least one legal individual for enabling a user to determine whether or not to make a selection decision about the at least one legal individual; and in response to a user selection, enabling one or more different options for displaying the case history of the at least one legal individual for user selection; wherein the user interface is configured to display a listing of legal personnel and associated one or more representative matters; wherein the user interface is configured to display an event, disposition, and attachment associated with the one or more representative matters.

This application claims the benefit of priority to U.S. Provisional Patent Application No. 63/215,617 filed on Jun. 28, 2021 at the United States Patent and Trademark Office, the contents of which are incorporated in its entirety.

### FIELD OF THE INVENTION

The present invention generally relates to Ranking based Systems based on the historic performance of certain professionals including attorneys.

### BACKGROUND OF THE INVENTION

There are about 1.34 million attorneys in the USA. Attorneys tend to believe that they are one of the best law firms—with some of the most impressive lawyers in the marketplace—but does the rest of the world know, too? To show clients and prospects how attorneys measure up, they need a law firm ranking performance. Yet, marketers and law firm management often lack the time and resources to undertake the tasks of identifying, executing, and leveraging ranking opportunities that a comprehensive ranking strategy requires.

### BRIEF SUMMARY OF THE INVENTION

Accordingly, it is desirable to provide ranking methods and systems to assist the public and the attorneys to search for the best attorney based on at least publicly available data, history, and case depositions in different areas of law by user selection.

In an exemplary embodiment, a method for generating data for evaluating the legal experience of legal personnel is provided. The method includes populating a user interface with data about past case history of at least one legal individual for enabling a user to determine whether or not to make a selection decision about the at least one legal individual; and in response to a user selection, enabling one or more different options for displaying the case history of the at least one legal individual for user selection; wherein the user interface is configured to display a listing of legal personnel and associated one or more representative matters; wherein the user interface is configured to display an event, disposition and attachment associated with the one or more representative matters; wherein the user interface displays a score associated with the legal personnel that is calculated based on a plurality of attributes comprising representative cases, recent representative matters, and years of experience; and wherein the score is calculated using an intelligent model that compares a set of legal personnel that are selected by the user using selection options available in the user interface.

In at least one exemplary embodiment, the method further includes the user interface that displays a pre-set set of options for user selection to enable the user to determine one or more categories of information about the legal individual by a one-click action.

In at least one exemplary embodiment, the method further includes the intelligent model that associates one or more legal individuals that are conflicted or not in conflict with respect to one or more representative matters that are displayed in the user interface.

In at least one exemplary embodiment, the method further includes the intelligent model searches one or more notices of distribution for the legal individual associated with one or more representative matters to display relevant information in one or more fields in the user interface to the user to enable the user selection of at least one legal individual.

In at least one exemplary embodiment, the method further includes the relevant information in one or more fields comprising: event type, disposition, and party names.

In at least one exemplary embodiment, the method further includes the event type comprises at least a type of motion, brief, or notice of a late filing.

In at least one exemplary embodiment, the method further includes the intelligent model configured to determine whether or not a case is stored based on searching data associated with a representative matter and a case stored or retention field in a calendar associated with a party or representative of the representative matter.

In at least one exemplary embodiment, the method further includes the intelligent model configured to determine based on the calendar whether the case is stored as an active case in the appellant case or if the case is a non-active case as the appellant case.

In at least one exemplary embodiment, the method further includes the intelligent model configured to determine based on the number of active cases or non-active cases a particular legal individual is handling and estimate the amount of available time the legal personnel spends on a new case.

In at least one exemplary embodiment, the method further includes the intelligent model configured to determine the number of days to the resolution of a representative matter and a disposition of the representative matter.

In at least one exemplary embodiment, the method further includes the intelligent model configured to determine the number of days to the resolution of a representative matter and a disposition of the representative matter.

In at least one exemplary embodiment, the method further includes the intelligent model configured to present a set of options for selection by the user that includes an option comprising the public disciplinary history of the legal personnel.

In at least one exemplary embodiment, the method further includes upon selection of the option for the public disciplinary history of the legal personnel, a listing is presented in the user interface of one or more actions related to the legal discipline of the legal personnel.

In another exemplary embodiment, a method is provided for navigating data related to a legal professional. The method includes displaying a graph with multiple axes mapped to a set of fields including experience data, case data, and evaluation score; and enabling a user to select an item associated with one or more axes in a dropdown menu and mapping a point position on the graph that is associated with the item selection.

In at least one exemplary embodiment, the graph is a two-dimensional graph that maps in accordance with at least one item selection by the user, a set comprising attributes of the legal professional including at least experience and representative matter to an evaluation score displayed on the two-dimensional graph.

In at least one exemplary embodiment, the graph is a three-dimensional graph that maps in accordance with at least one item selection by the user, a set including attributes of the legal professional including at least experience, representative matter, and an evaluation score displayed on the three-dimensional graph.

In yet another exemplary embodiment, a system for generating data for evaluating the legal experience of legal personnel is provided. The system includes a processor configured to populate a user interface with data about past case history of at least one legal personnel for enabling a user to determine whether or not to make a selection decision about the at least one legal personnel; and in response to a user selection, a processor is configured to display one or more different options in the user interface of a case history of the at least one legal personnel for user selection; wherein the user interface is configured to display a listing of legal personnel and associated one or more representative matters; wherein the user interface is configured to display an event, disposition and attachment associated with the one or more representative matters; wherein the user interface displays a score associated with the legal personnel that is calculated based on a plurality of attributes including representative cases, recent representative matters, and years of experience; and wherein the score is calculated by the processor using an intelligent model that compares a set of legal personnel that are selected by the user using selection options available in the user interface.

In at least one exemplary embodiment, the system further includes the user interface that displays a pre-set set of options for user selection to enable the user to determine one or more categories of information about the legal personnel by a one-click action.

In at least one exemplary embodiment, the system further includes the intelligent model that associates one or more legal personnel that are conflicted or not in conflict with respect to one or more representative matters that are displayed in the user interface.

In at least one exemplary embodiment, the system further includes the intelligent model that is configured to determine whether or not the person is an actual trial individual or is an appellate level individual.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which

FIG. 1 illustrates a diagram of two options to access the typical website that contains the references of the Appeal lawyers, in accordance with various exemplary embodiments;

FIG. 2 displays a list of legal areas or case types of search box in which a user is seeking legal counseling or intends to retain an attorney having a demonstrated experience in that field or the area of the case law;

FIG. 3. shows a search box which contains the search area for an attorney's name with a bar number search option.

FIG. 4 shows the sign-in and sign-up dialogue box where a user can provide necessary information to open an account or to login into an existing account;

FIG. 5 shows that a user can enter the attorney's name in the search box.

FIG. 6 explains the possibility when an attorney's specific name or bar number results are not found in the scrapped database;

FIG. 7 shows an abbreviated mapping of the long text strings for the courts to a small abbreviation for ease of use;

FIG. 8 shows how the information related to attorney's name, the number of cases they filed and their ranking as determined by their case participation.

FIG. 9 shows a search bar with a web link that can be copied by a user, and it can be sent to other users who can access this web link by clicking on it;

FIG. 10 shows an option to copy a web link and uniquely identify using a random number index pointer

FIG. 11 shows the information box which displays and provides access to attorneys' different types of disciplinary actions;

FIG. 12 shows the summary of the Attorney's Profile and in the summary view, it also provides the option for the user to access a case represented by this attorney for a specific amount of time.

FIG. 13 shows that a user can find the attorney experience by looking at the earliest case the attorney filed and the filing of the latest case the attorney filed;

FIG. 14 shows the summary option where a user can easily identify a particular case type that the attorney has represented;

FIG. 15 shows that the user can search for all attorneys who have represented the assault cases

FIG. 16 shows the option that displays the attorneys who have filed the motion to withdraw in their cases;

FIG. 17 illustrates all cases accessible web links in which a said attorney filed a motion to withdraw;

FIG. 18 shows the case numbers which were transferred to other attorneys as one attorney replaces another attorney.

FIG. 19 shows a summary profile of an exemplary attorney with its case history profile.

FIG. 20 illustrates an algorithm to ensure that ALL Attorneys and their cases will be properly identified and processed;

FIG. 21 illustrates an Algorithm Flowchart to count the number of “Motions to Withdraw” cases for an Attorney;

FIG. 22 illustrates a snapshots directly taken from the court website to display the text strings like “Motion of Attorneys to withdraw” under the “Event Type” Column;

FIG. 23 illustrates a diagram of a webpage that a user can use to identify the number of cases in which attorneys filed their “Appellate Briefs”, in accordance with various exemplary embodiments;

FIG. 24 illustrates the summary profile of an attorney. The Disposition Column shows the web link against each case in which an attorney has filed one or multiple appellate briefs;

FIG. 25 illustrates a snapshot directly taken from the court website to display the case number, text strings like “appellate briefs” under the “E Briefs” Column.

FIG. 26 illustrates an Algorithm Flowchart to count the number of “Appellate Brief” cases for an Attorney

FIG. 27 illustrates a snapshot directly taken from the court website and it shows different types of appellate briefs filed by an attorney

FIG. 28 illustrates a webpage where column shows the number of Andres Briefs filed by the induvial attorney on their client's behalf;

FIG. 29 shows the summary of the attorney's profile who has filed “Andres Briefs” in his different client cases;

FIG. 30 illustrates a snapshot directly taken from the court website to display the text strings like “Appellate Andres Briefs filed” under the “Appellate Briefs” Section.

FIG. 31 shows an Algorithm Flowchart to count the number of “Andres Brief” cases that an Attorney has filed;

FIG. 32 shows a typical case reference indicating the presence of the “Andres Brief” in the “Appellate Briefs” Section

FIG. 33 shows the webpage which displays the working relationship with other attorneys;

FIG. 34 shows the working relationship of an attorney with other attorneys further showing the two columns which reports the results of an attorney working together with other attorneys and that column is displayed.

FIG. 35 shows the summary profile of an attorney who worked with another attorney in a series of cases;

FIG. 36 shows the summary profile of an attorney who worked against another attorney in a series of cases and he represented the opposing parties;

FIG. 37 illustrates a diagram of the algorithm to ensure that ALL Attorneys and their cases will be properly identified and processed, in accordance with various exemplary embodiments;

FIG. 38 illustrates a sub-routine which accesses Tables to accesses relevant documents;

FIG. 39 illustrates a flowchart which essentially makes a comparison between the name entries of attorneys to be found in the Notice with the entries on the Representative Column;

FIG. 40 shows the demarcation between the attorneys working together and the attorneys working against each other under the respective columns;

FIG. 41 illustrates a diagram of the demarcation between the attorneys working together and the attorneys working against each other under the column Parties, in accordance with various exemplary embodiments;

FIG. 42 illustrates a diagram of the tabular format where two separate two columns display the relevant information, in accordance with various exemplary embodiments;

FIG. 43 illustrates a diagram of the details of the cases associated with an attorney, in accordance with various exemplary embodiments;

FIG. 44 shows a table that represents the actual case information about calculating the time spent on concluding a case;

FIG. 45 illustrates a diagram of an algorithm that ensures that all Attorneys and their cases will be properly identified and processed, in accordance with various exemplary embodiments;

FIG. 46 illustrates a diagram of a process to determine if the case is a concluded or not, in accordance with various exemplary embodiments;

FIG. 47 shows an algorithm which determines through its last step whether a typical “jth” case belongs to “ith” attorney or not.

FIG. 48 illustrates a diagram of an algorithm expressed through a flowchart, in accordance with various exemplary embodiments;

FIG. 49 illustrates a diagram of an Algorithm that eventually calculates the time it took to conclude a case, in accordance with various exemplary embodiments;

FIG. 50 illustrates a diagram of a table that reports the pending duration of the cases and a column that shows the average number of case events, in accordance with various exemplary embodiments;

FIG. 51 illustrates a diagram of the profile exemplary profile of the attorney, in accordance with various exemplary embodiments;

FIG. 52 shows a table that represents the actual case information about calculating the time spent on a pending case;

FIG. 53 illustrates a diagram of an Algorithm to ensure that ALL Attorneys and their cases will be properly identified and processed, in accordance with various exemplary embodiments;

FIG. 54 illustrates a diagram of the details about an Algorithm that can be used to determine if a case # is a pending case for an attorney, in accordance with various exemplary embodiments;

FIG. 55 shows a programming sub-routine where the Program searches for the “Notice” under the “Document Column

FIG. 56 shows an Algorithm which is used to report the result as “Time to conclude the Case” and populate the respective Table along with the identified “Party Type”

FIG. 57 displays tabular profile information in Table. The tabular profile of an attorney can contain the name of the attorney. The information related to Board Certified is also shown;

FIG. 58 illustrates a diagram of an option where a user can search and identify the type of certifications attorneys possess, in accordance with various exemplary embodiments;

FIG. 59 illustrates a diagram of an option where attorneys can be listed based on their countries/stated licensed certification, in accordance with various exemplary embodiments;

FIG. 60 illustrates a diagram of a search box where a user can enter the language name to search for all attorneys who offer language assistance in that particular language, in accordance with various exemplary embodiments;

FIG. 61 illustrates a diagram of an Attorneys with Public Disciplined History, in accordance with various exemplary embodiments;

‘FIG. 62 shows the Summary of the Attorney's Profile so if a user clicks on text the court webpage describes all the disciplinary related actions that took place against the said attorney;

FIG. 63 shows the profile of the an exemplary attorney Joseph to illustrate there can be one or multiple disciplinary actions that took place against the said attorney

FIG. 64 illustrates a diagram of a “Case Type Table” which contains numerous types of cases, in accordance with various exemplary embodiments;

FIG. 65 describes a procedure to mathematically and statistically analyze the concept of Points Assignments based on the historic performance of attorneys;

FIG. 66 illustrates an algorithm to ensure that ALL Attorneys and their cases will be properly identified and processed;

FIG. 67 shows an algorithm that searches for all the cases represented by attorneys and identifies the Case Type;

FIG. 68 describes an algorithm which finds out if the “jth” case # is a concluded CASE or a non-concluded case

FIG. 69 shows the text string that is used to conclude if the case is active or has been stored, meaning concluded;

FIG. 70 illustrates an Algorithm which is used to identify the names of the attorneys who are participating in the “jth” Case;

FIG. 71 shows multiple tables to identify “Party Types” listed for different case types;

FIG. 72 illustrates a diagram of an algorithm that is used to determine the case classification in any of the Texas Appellate Courts, in accordance with various exemplary embodiments;

FIG. 72 shows an algorithm that is used to determine a typical “jth” case classification in the Texas Court of Appeals Case, the Texas Supreme Court Case, or the Texas Court of Criminal Appeals Case;

FIG. 73 shows a procedure to identify the court identification by reading the case number format. This procedure enables the program to only read the case number format and identify the court where this case was deposed.

FIG. 74 shows case events in a typical case which appear in the case records of a case. These case events reveal how the attorneys involved in this case are making the progress

FIG. 75 shows a procedure for identifying and searching a “Text String” to be found under the “Case Events Section” of a case.

FIG. 76 shows the flow of the program based on the value of the text strings it reads from the row entries listed in the “Event Type” Column;

FIG. 77 shows the processing of “text strings” types based on the Results found in the “Case Event Types”.

FIG. 78 illustrates the processing of an Event Type identification Algorithm. The result obtained through this process can be fed to different Tables.

FIG. 79 directs the Program to search for a list of “text strings” provided in Tables and assign the corresponding points to the Petitioner and the Respondent.

FIG. 80 shows a specific case format, for example for the “PD Case Type format used in the Texas Court of Criminal Appeals Cases;

FIG. 81 illustrates a diagram of the disposition case category and illustrates the methods to assign points based on the actions taken on the case, in accordance with various exemplary embodiments;

FIG. 81 shows the disposition case category as an example, “PDR DISP Refused”;

FIG. 82 shows a specific case format, for example for the “WR” Case Type format used in the Texas Court of Criminal Appeals Cases;

FIG. 83 shows a specific case format, for example, for the “AP-XX, XXX”:

FIG. 84 illustrates another method of displaying results through 3-D chart drawings. A graphical display system is used to draw 3-D graphs.

FIG. 85 illustrates another method of displaying results through 2-D chart drawings;

FIG. 86 illustrates a system to integrate and implement different databases that can be connected together to refine a broader spectrum of results related to attorneys.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In various embodiments, a ranking method is provided that can identify the best attorneys who have filed the greatest number of cases across a jurisdiction including within a State. A ranking system that can identify a set of attorneys who have filed the greatest number of cases in a very specific area of law. For example, if a potential client is searching for an Attorney to handle the client's matter in DWI (Driving While Intoxicated) Case, then obviously client would like to hire an attorney who has a proven record and demonstrable experience specifically in handling DWI Cases and not handling matters in the divorce cases. This would readily help clients to decide if the attorneys' case filing experience is recent and up to date in the specific appeal category a client would be considering them to retain.

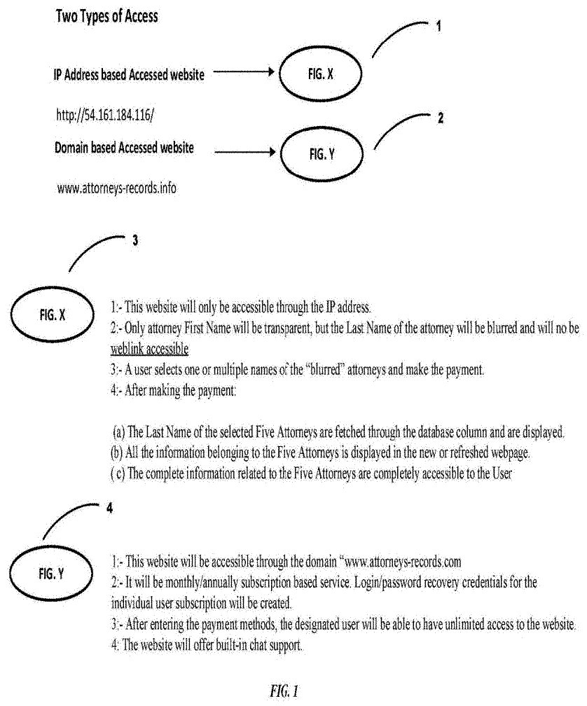

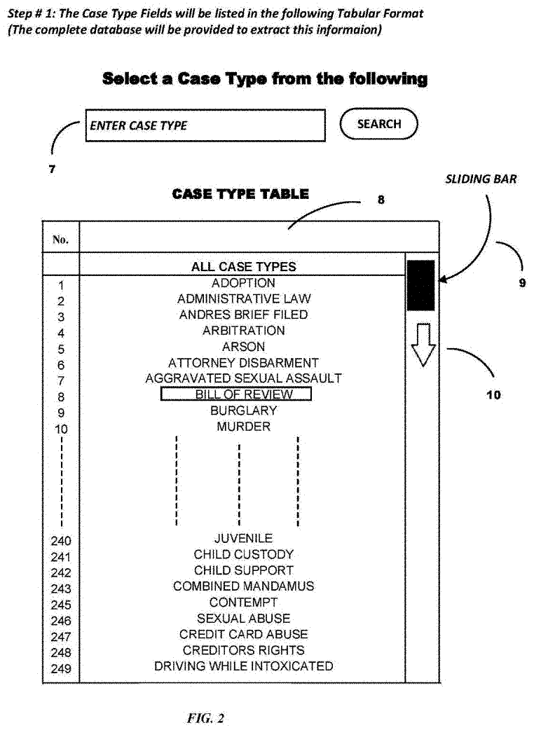

FIG. 1 shows two options to access the typical website that contains the references of the Appeal lawyers. The reference of FIG X 1 shows that this website can be available through an IP address with a required random “hash-number” required to access the website. This type of configuration will provide an option for a user to select a limited and specific number of attorneys whom he would like to get more information about it. The references of FIG Y 2 point to an option where the users can typically log in, set up an account, and enjoy all the features of the website. Further the details and functionality of both FIG. X, 3, and FIG. Y is provided

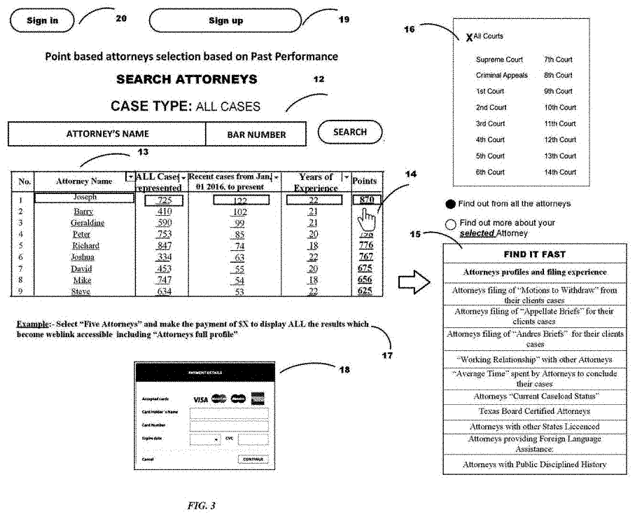

FIG. 2 displays a list of legal areas or case types of search box 7 in which a user is seeking legal counseling or intends to retain an attorney having a demonstrated experience in that field or the area of the case law. A user can just type in the “case type” 7. Case Table 8 provides a list of Case Types covering all legal areas in which a user may seek the assistance of an attorney. A user can also use sliding bar 9 to the area of the case law to explore different listed areas of case law. A user can slide bar 9 in any direction 10.

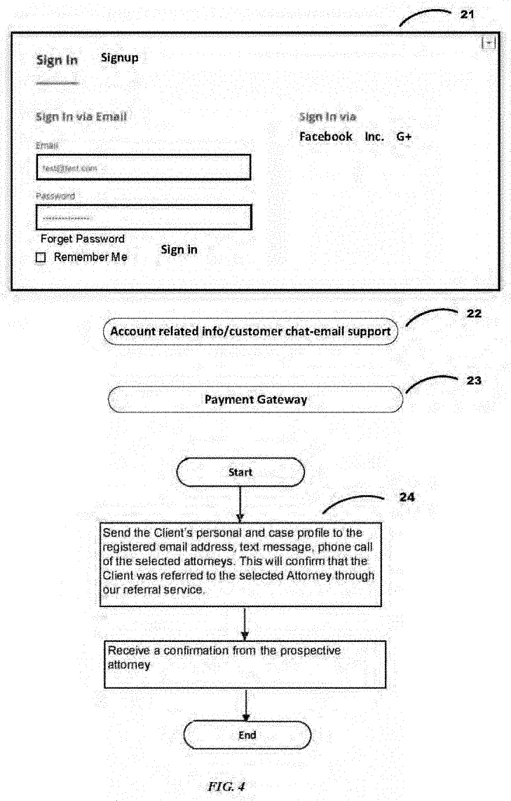

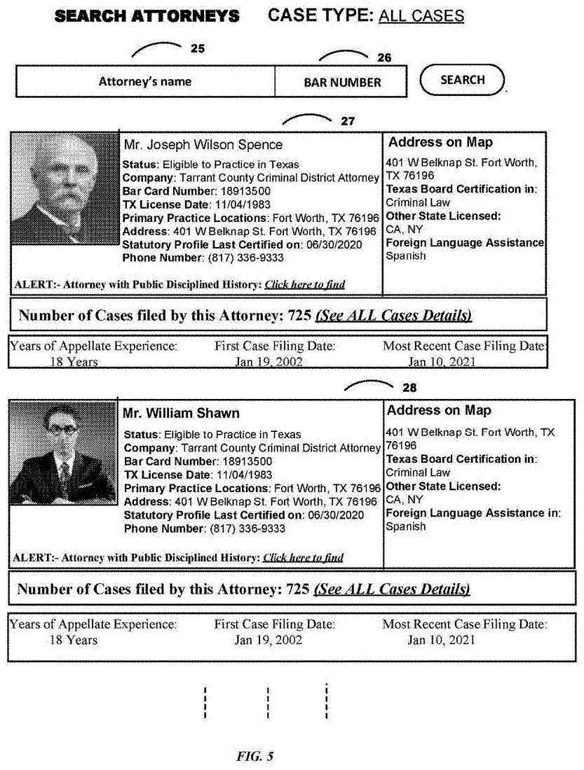

FIG. 3. Shows a search box 12 which contains the search area for an attorney's name with a bar number search option. FIG. 4 also shows a list of attorneys displayed in a tabular format 13, with its table having multiple columns showing attorneys' names, the number of total cases they represented, and the number of cases they represented within a certain time period. For example, for Jan. 1, 2016, to the present. Another column to represent the number of years of experience. Another column reports the number of points an attorney has earned based on their case representation. FIG. 4 also provides you with an option to “sign-in” 20 to your account, and signup to your account 19. FIG. 4 also shows a multiple selection box 16 in which a user can select one or multiple courts as his case search selections. FIG. 4 also shows a selection box 15 “FIND IT FAST” showing multiple search options that a user can choose from to find several different aspects about a single attorney or multiple attorneys. A user can focus to find the certain aspects of one attorney or multiple aspects of attorneys by using the two options presented through the two radio buttons 14. FIG. 4 also shows a payment processing box 18 that a user can use to make his payment. The payment amount that the user process will enable him to gain access to the attorneys' and different options 17.

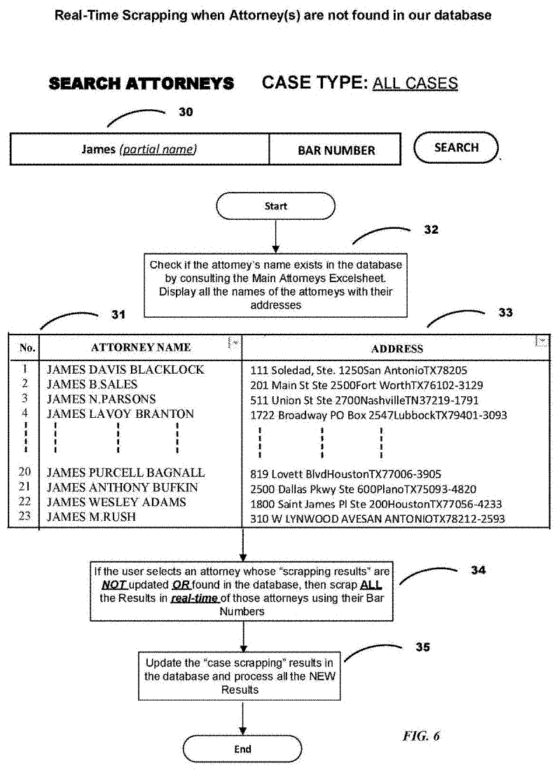

FIG. 4 shows the sign-in and sign-up dialogue box 21. A user can provide necessary information to open an account or to login into an existing account. It further provides account-related info, and chat email support 22. A payment gateway 23 is also integrated to process payment. Further FIG. 5 shows a flow chart 24 that can send an email, chat, or place a phone call to the attorney selected by the Client. This email to the attorney will trigger the confirmation of the attorney referral fee.

FIG. 5 shows that a user can enter the attorney's name in the search box 25. The search will display the attorney's name and their respective profiles matching fully or partially with the attorney's name requirements. In addition, a user can enter Bar Number 26 to search for different attorneys' profiles. In this example, two attorney profiles 27 and 28 are shown.

FIG. 6 explains the possibility when an attorney's name 30 or bar number results are not found in the scrapped database. If the attorney's name exists in the database by consulting the main attorney's Excel sheet, then it will display all the names of the attorneys with their addresses. In this event, the Program first finds all the names of the attorneys or the bar numbers which are in the master's contact list of all the attorneys, and it displays all the results in the tabular form with the attorney's name 31 and address columns 32. If the profile and the scrapped case data are not current or if it does not exist in the current database, then the real-time scraping is performed by the Program as shown in step 34. The Program will update the “case scrapping” results in the database and it processes all the newly received results as shown in step 35.

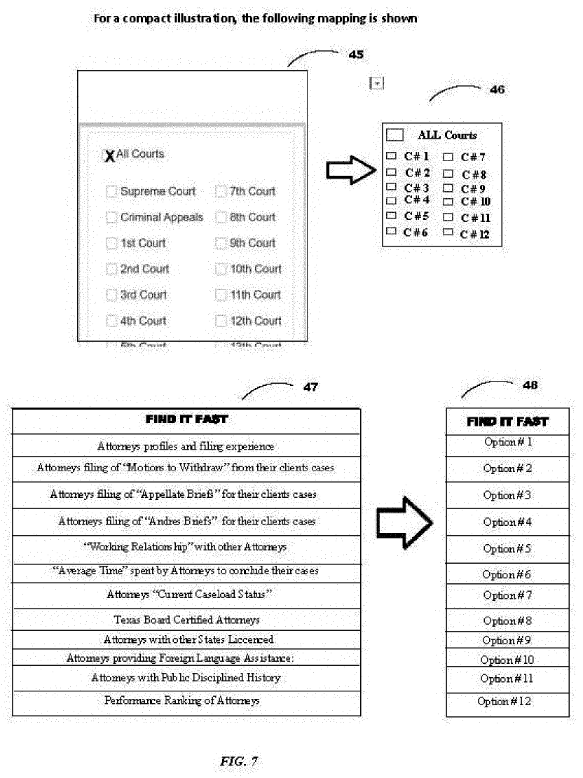

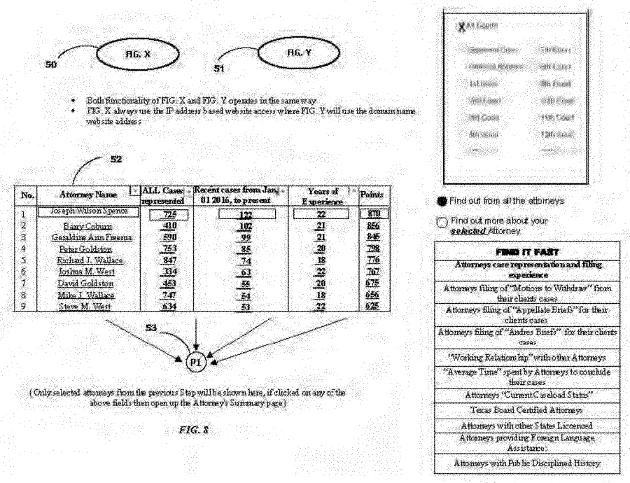

FIG. 7 shows an abbreviated mapping of the long text strings 45 for the courts to a small abbreviation 46 for ease of use. Similarly, the functions listed with the long text string 47 to an abbreviated version of the smaller text 48

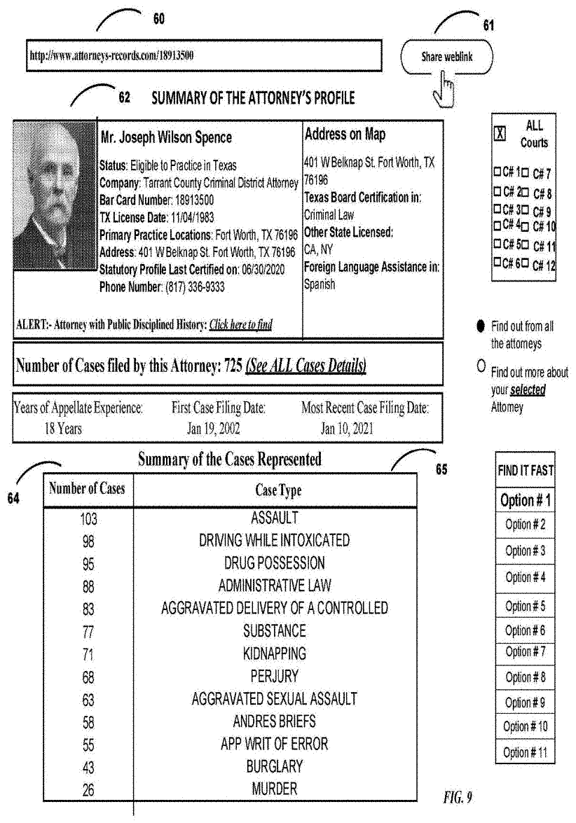

FIG. 8 shows how the information is displayed. FIG X. 50 relates to selecting a certain number of attorneys and then desiring to find the respective profiles. FIG Y 51 presents a scenario where a user will have access to all the attorneys and their respective profile features 52 without any limitation.

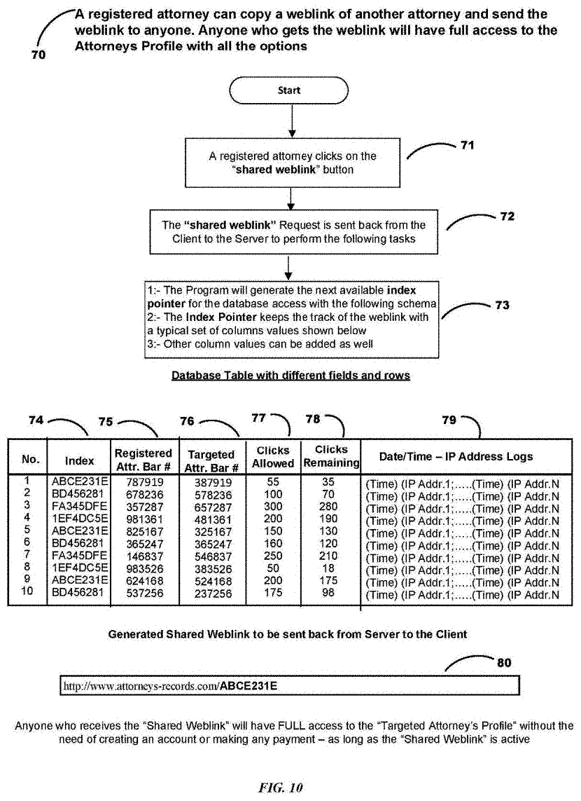

FIG. 9 shows a search bar 60 with a web link that can be copied by a user, and it can be sent to other users who can access this web link by clicking on it. This step is done by clicking the share box 61 which will generate the web link that can be sent to anyone, the person who receives the said web link will be able to access only that particular attorney's profile with any payment or requiring to establish a user’ account. The attorney's profile is shown in the information box 62. The information box 64 displays the number of cases 64, case type 65 that the said attorneys have handled.

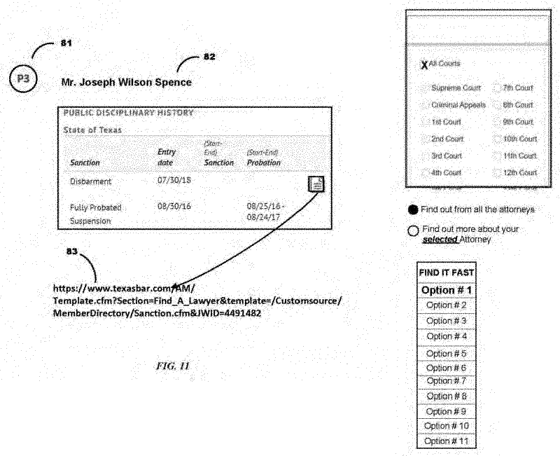

FIG. 10 shows an option 70 to copy a web link and uniquely identify using a random number index pointer. In step 71, A registered attorney clicks on the “shared web link” button, in step 72, The “shared web link” Request is sent back from the Client to the Server to perform the following tasks. In step 73, the Program generates the next available index pointer. A pointer is used to identify different field-related values. Index 74 keeps track of the different functions of the browser. An index 74 can uniquely identify Registered Attorney, Bar #, 75, Targeted Attorney Bar #76, Clicks Allowed 77, Clicks remaining 78 and date/time and the IP address location where the access was initiated 79. A sample of the generated web link is shown in the information box 80.

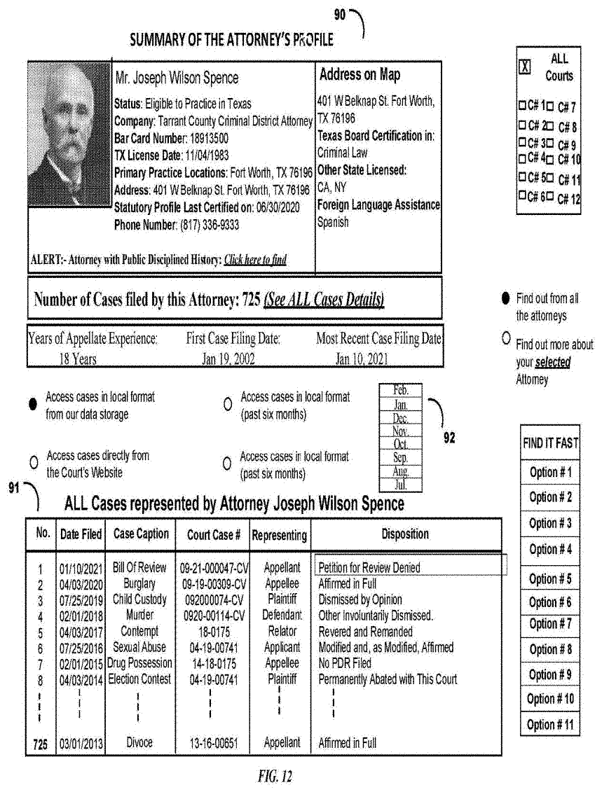

FIG. 11 shows the information box 82 which displays and provides access to attorneys' different types of disciplinary actions. This also includes a web link 83 that can take a user to a different webpage where the disciplinary related actions of the attorneys are displayed.

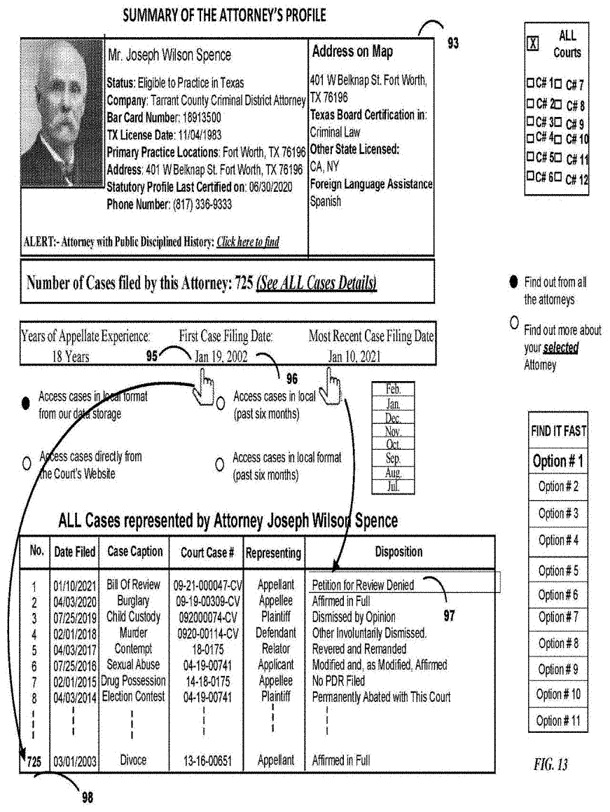

FIG. 12 shows the summary of the Attorney's Profile 90. In the summary view, we also provide the option for the user to access a case represented by this attorney for the past 6 months 92. In the information window 91, different formations related to the cases are displayed, for example, the filing date of the case, case caption, court case #, the party being represented by the attorney, and the case disposition.

FIG. 13 shows that a user can find the attorney experience by looking at the earliest case the attorney filed and the filing of the latest case the attorney filed. The time duration between these two cases will reflect the attorney's appellate filing experience.

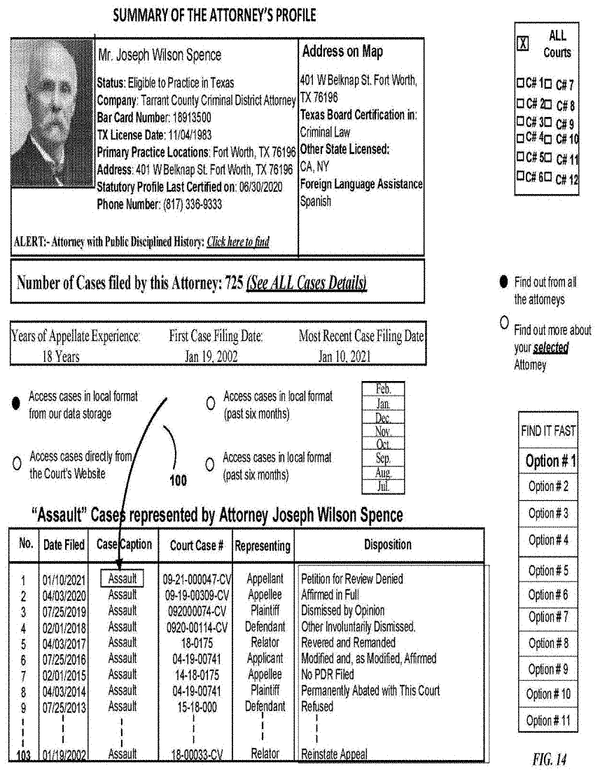

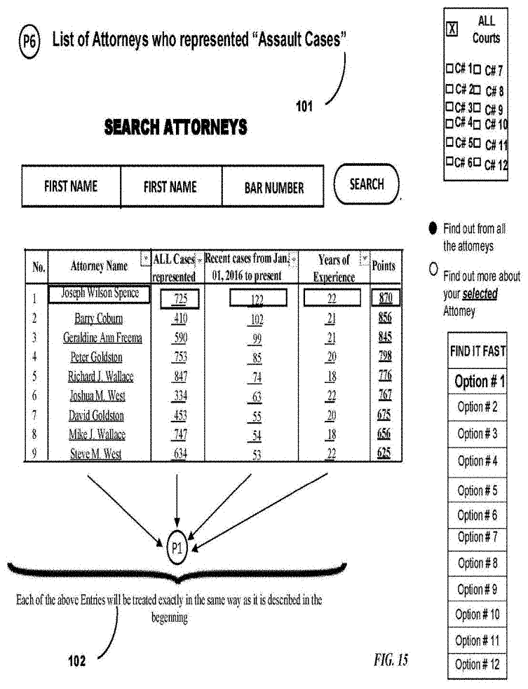

FIG. 14 shows the summary option where a user can easily identify a particular case type that the attorney has represented. As an example, a user can search for a case category of assault 100 that the attorney has represented.

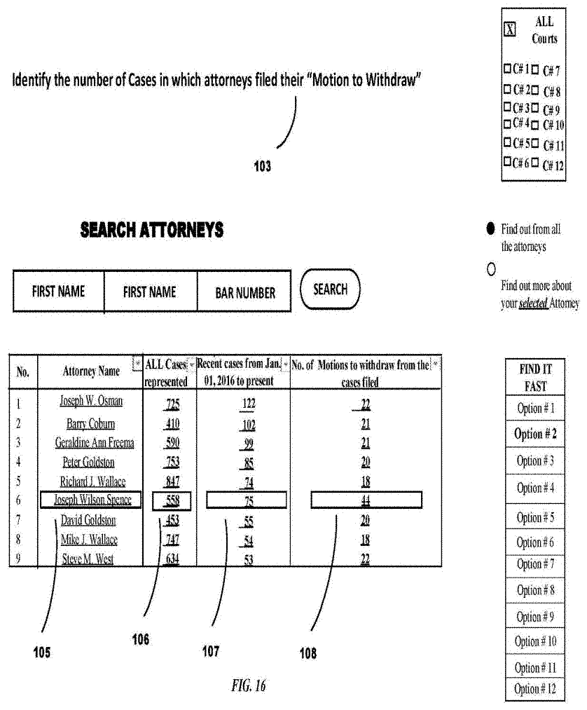

FIG. 15 shows that the user can search for all attorneys who have represented the assault cases 101, similarly, a user can go through the list of other attorneys who have represented assault cases and can further search for different options under each attorney 102.

FIG. 16 shows the option that displays the attorneys who have filed the motion to withdraw in their cases 103. As shown in this example an attorney Joseph Wilson Spence 105 filed a total number of 558 cases 106. The number of cases represented by the said attorney from Jan. 1, 2016, to the present is 75, reference 107. The said attorney filed a total number of 44 motions to withdraw in the cases he represented 108.

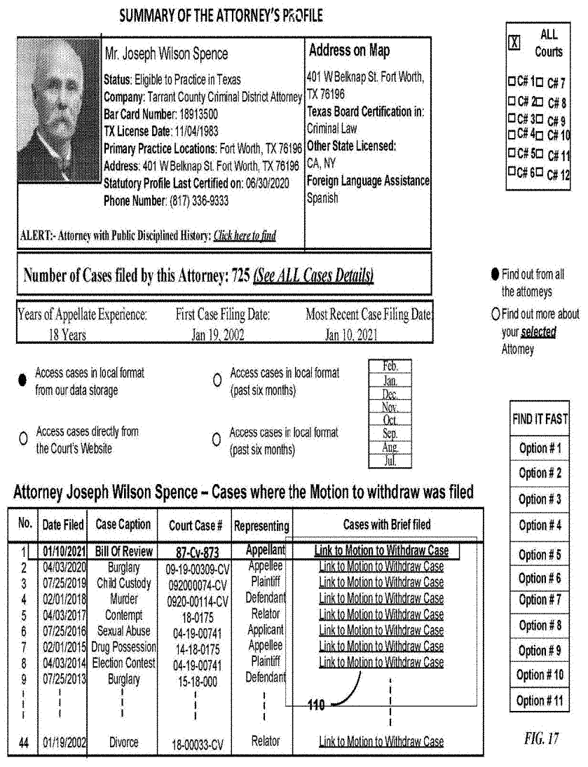

FIG. 17 illustrates all cases accessible web links in which a said attorney filed a motion to withdraw 110. A user can simply click on the accessible web links for each case in which the said attorney filed his motion to withdraw.

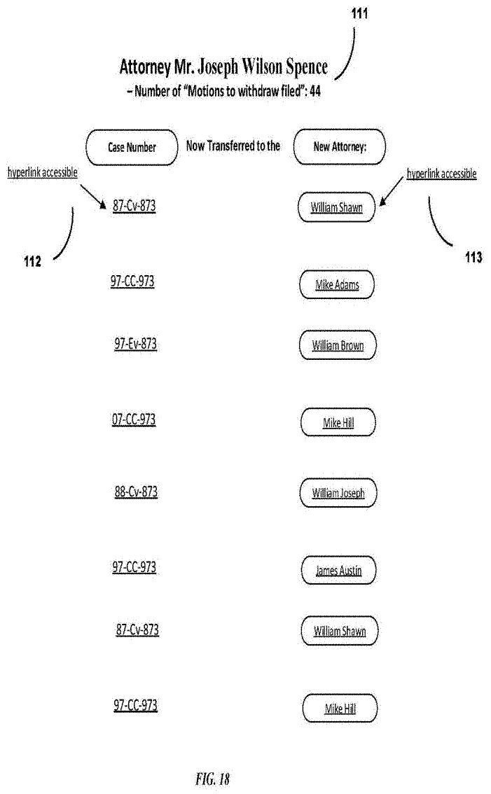

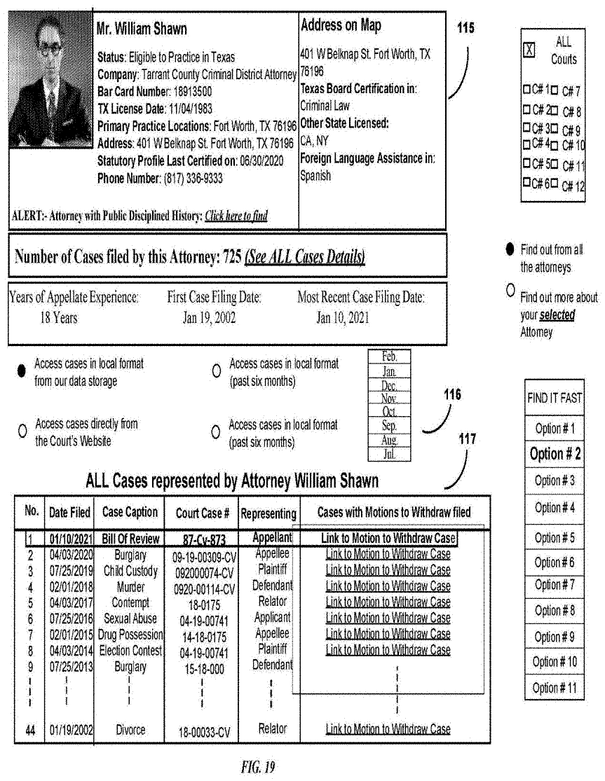

FIG. 18 shows the case numbers which were transferred to other attorneys because of the said attorney, Mr. Joseph Spence, 111 for his filings of the motions to withdraw. As illustrated, the said attorney Joseph Wilson Spence 101 filed his motion to withdraw in 44 cases. After filing these motions to withdraw in the case number, for example, 87-CV-873, 112, the case gets transferred to another attorney, for example, Williamson Shawn, 113.

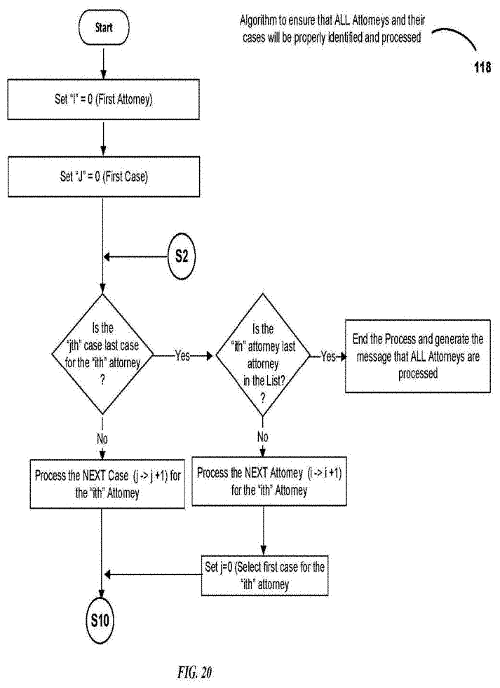

FIG. 19 shows a summary profile of an exemplary attorney, William Shown, summary profile 115. It also represents table 116 where a user can find the historic records of the said attorney's case filings. Column 117 lists the web links of the cases in which the said attorney filed his Motion to withdraw.

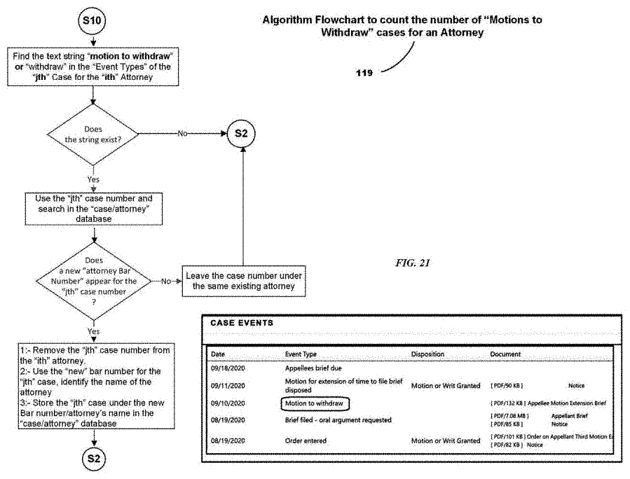

FIG. 20 illustrates an algorithm to ensure that ALL Attorneys and their cases will be properly identified and processed 118.

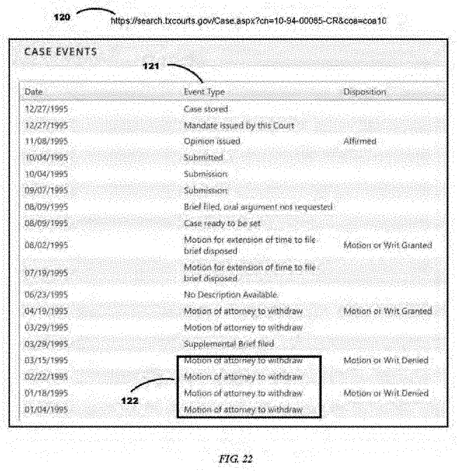

FIG. 21 illustrates an Algorithm Flowchart to count the number of “Motions to Withdraw” cases for an Attorney 119.

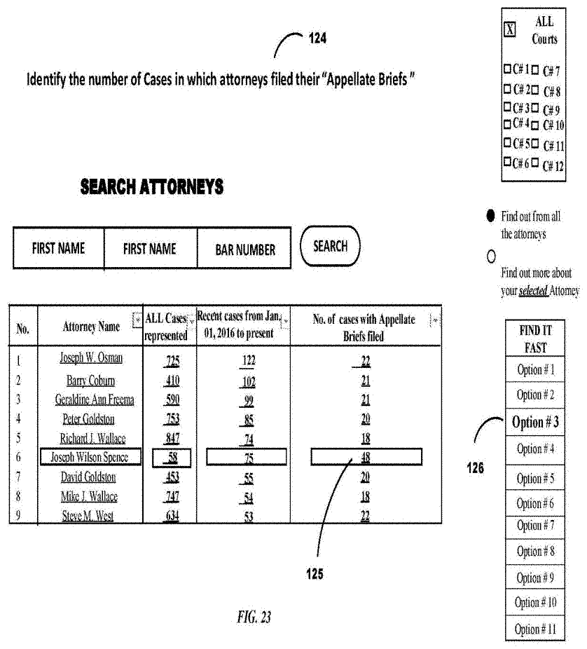

FIG. 22 illustrates a snapshot 120 directly taken from the court website to display the text strings like “Motion of Attorneys to withdraw” 122 under the “Event Type” Column

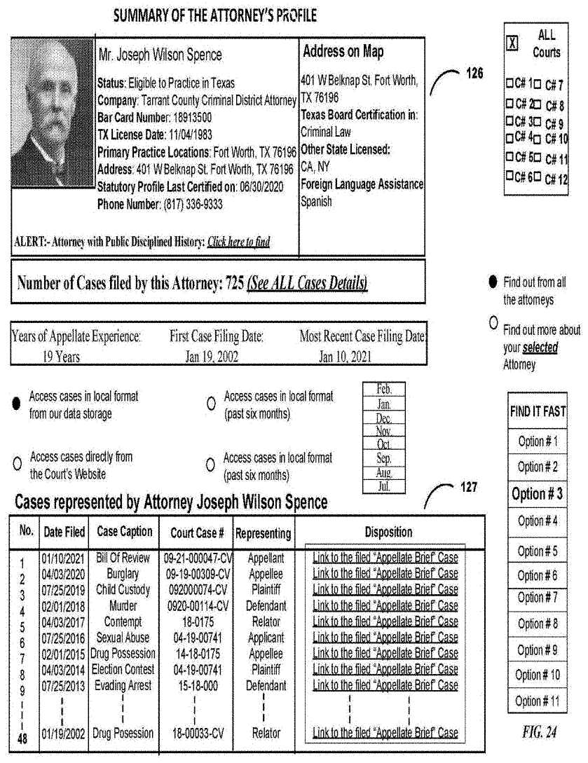

FIG. 23 illustrates a webpage 124 that a user can use to identify the number of cases in which attorneys filed their “Appellate Briefs” 125

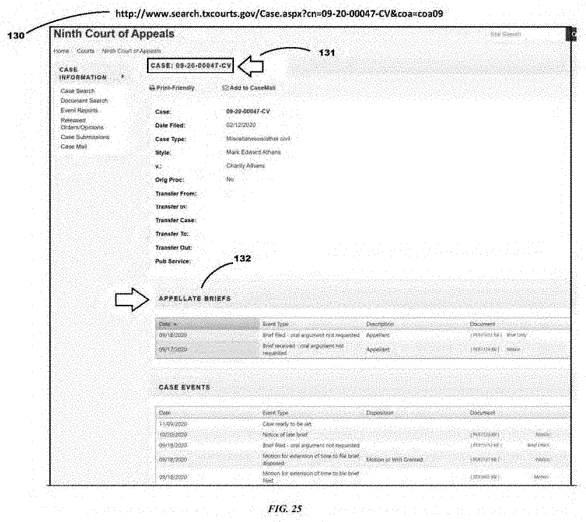

FIG. 24 illustrates the summary profile of an attorney 126. The Disposition Column 127 shows the web link against each case in which an attorney has filed one or multiple appellate briefs.

FIG. 25 illustrates a snapshot 130 directly taken from the court website to display the case number 131, text strings like “appellate briefs” 132 under the “E Briefs” Column.

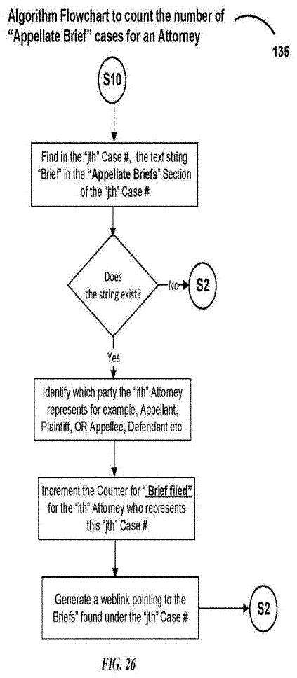

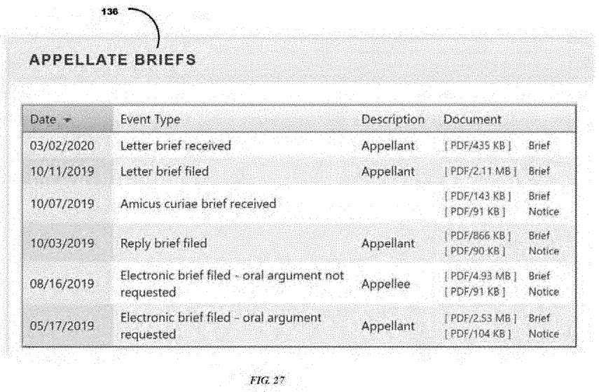

FIG. 26 illustrates an Algorithm Flowchart 135 to count the number of “Appellate Brief” cases for an Attorney.

FIG. 27 illustrates a snapshot directly taken from the court website and it shows different types of appellate briefs filed by an attorney 136.

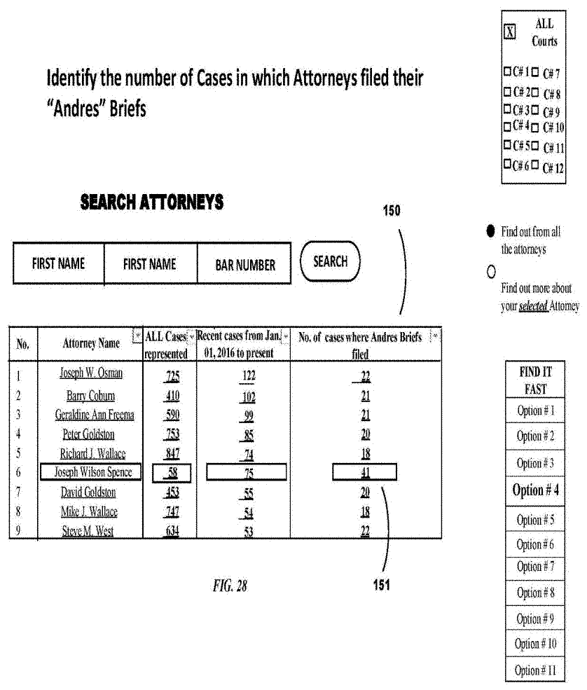

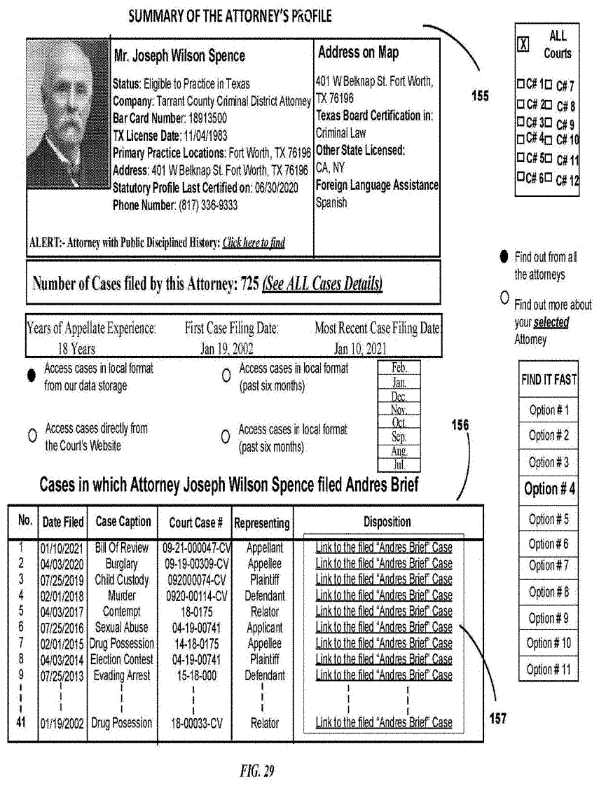

FIG. 28 illustrates a webpage where column 150 shows the number of Andres Briefs filed by the induvial attorney on their client's behalf. For example, an attorney has filed 41 Andre's briefs 151 while representing his clients.

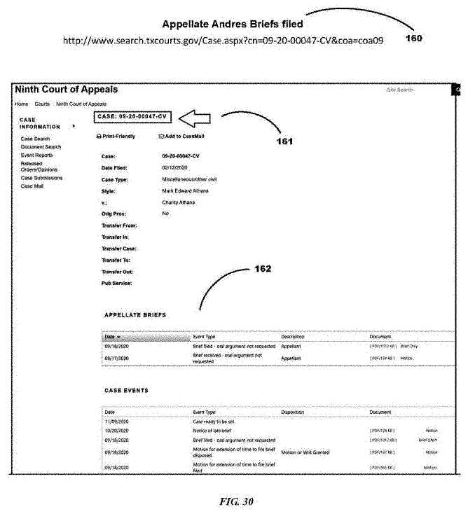

FIG. 29 shows the summary of the attorney's profile 155 who has filed “Andres Briefs” in his different client cases. Under disposition column 156, all the cases in which attorneys have filed Andres Briefs are displayed through the accessible web links 157.

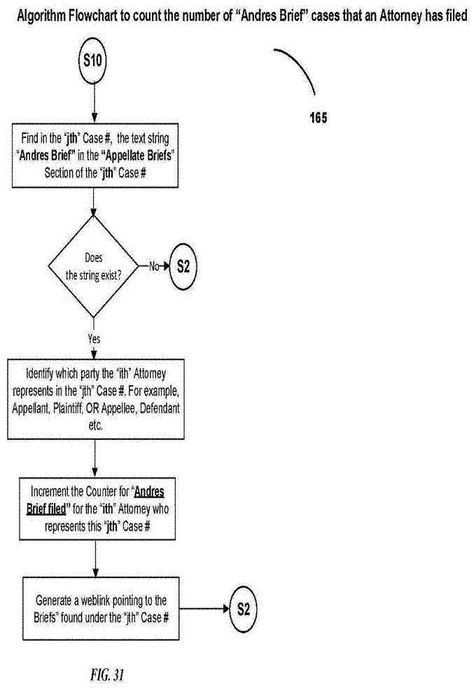

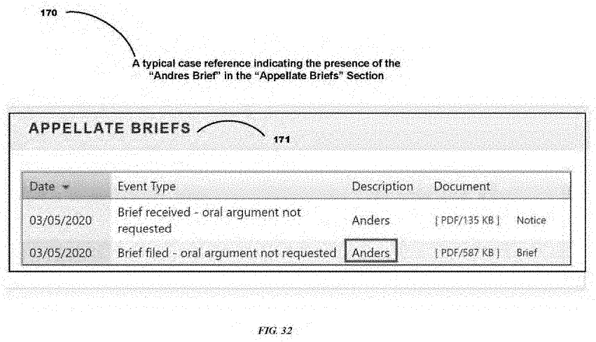

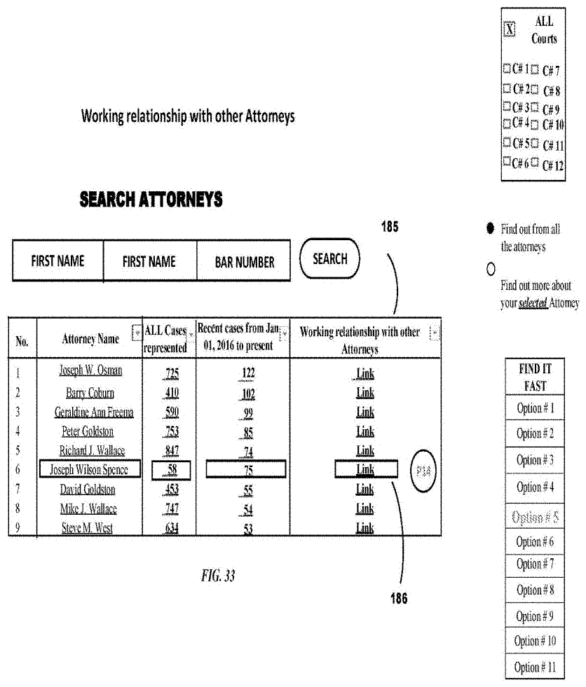

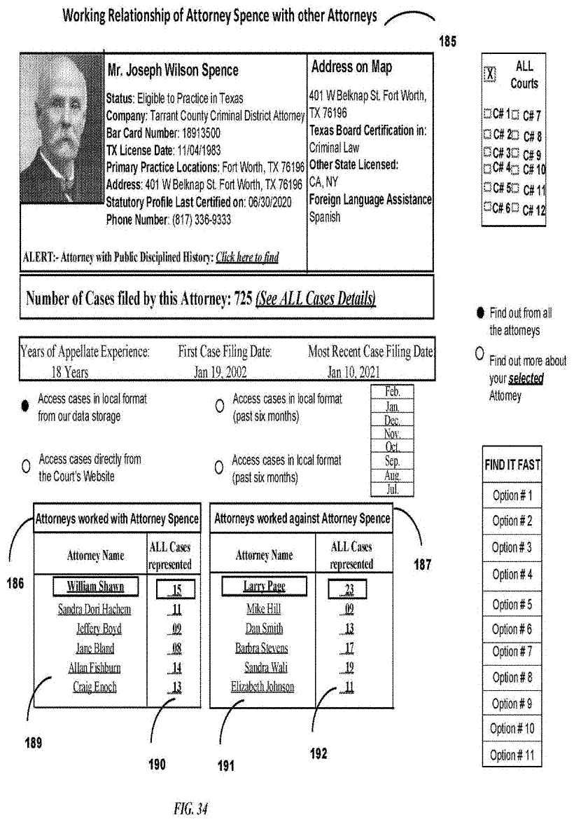

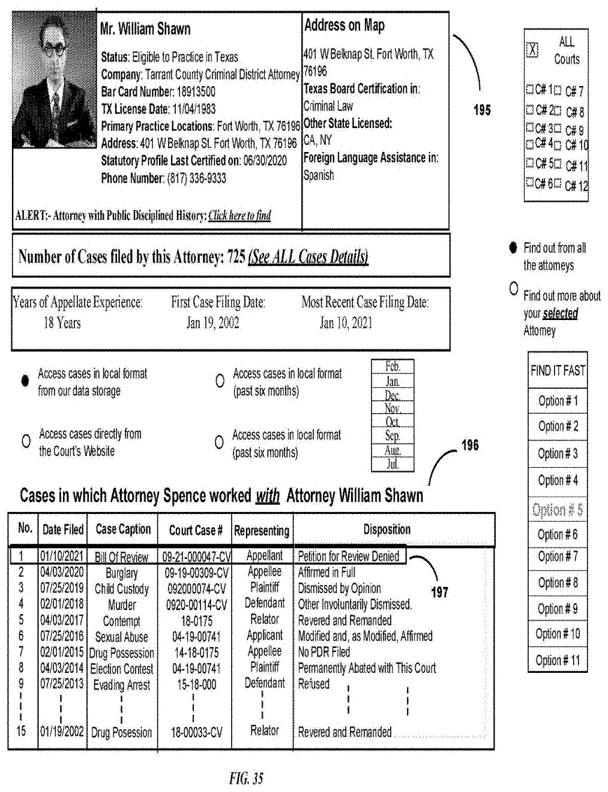

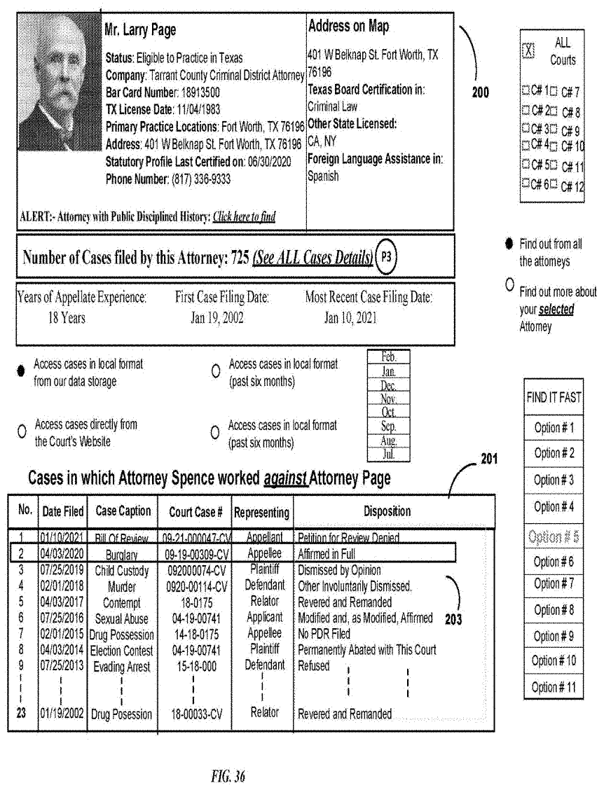

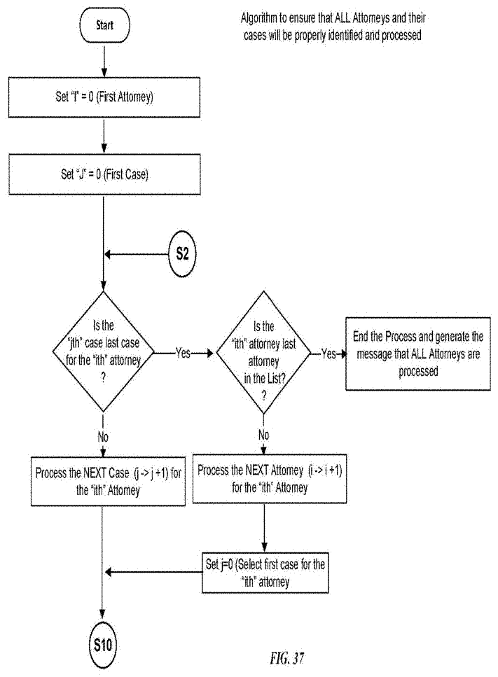

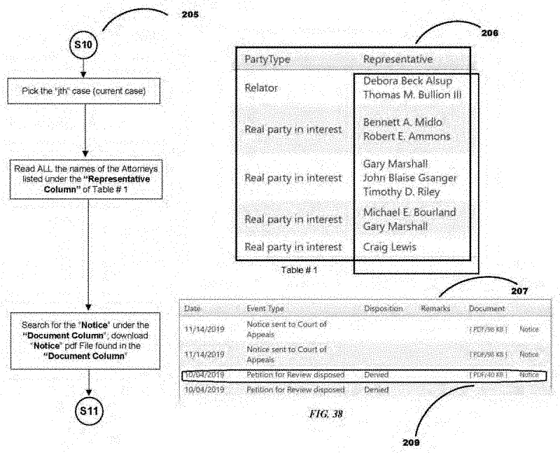

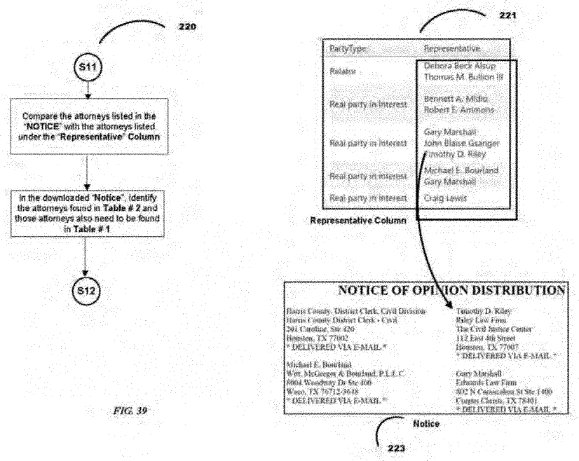

FIG. 30 illustrates a snapshot 160 directly taken from the court website to display the text strings like “Appellate Andres Briefs filed” 160 under the “Appellate Briefs” Section 162. Case number 161 contains the Andres Brief filed.

FIG. 31 shows an Algorithm Flowchart 165 to count the number of “Andres Brief” cases that an Attorney has filed.

FIG. 32 shows a typical case reference indicating the presence of the “Andres Brief” 170 in the “Appellate Briefs” Section 171

FIG. 33 shows the webpage which displays the working relationship with other attorneys. Column 185 provides web links 186 which provides access to the webpage showing the working relationship with other Attorneys.

FIG. 34 shows the working relationship of an attorney with other attorneys 185. There are two columns that report the results of an attorney working together with other attorneys and that column is displayed 186. Similarly, the other column 187 displays the list of other attorneys with whom an attorney has represented the opposing party. Column 189 shows the name of the attorneys and column 190 shows the number of cases each attorney represented who worked with the identified attorney. Similarly, column 191 lists the names of those attorneys who worked against the identified attorney and column 192 shows the number of cases that these attorneys 191 represented against the identified attorney.

FIG. 35 shows the summary profile of an attorney “William Shawn” 195 who worked with the attorney “Joseph Spence” (FIG. 4, 185) in a series of cases 196. Each entry in table 196 represents the information about a case in which the attorney “William Shawn” 195 worked together with the attorney “Joseph Spence”. A user can click on the embedded web link of case 197 to get the complete detail about the said case.

FIG. 36 shows the summary profile of an attorney “Mr. Larry Page” 200 who worked against attorney “Joseph Spence” (FIG. 4, 185) in a series of cases 203 and he represented the opposing parties. Each entry in table 201 represents the information about a case in which the attorney Mr. Larry Page” 200 worked against attorney “Joseph Spence”. A user can click on the embedded web link of case 203 to get the complete detail about the said case or each listed case.

FIG. 37 illustrates an algorithm to ensure that ALL Attorneys and their cases will be properly identified and processed.

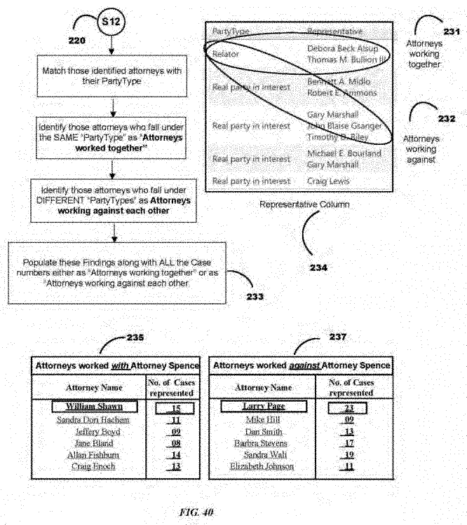

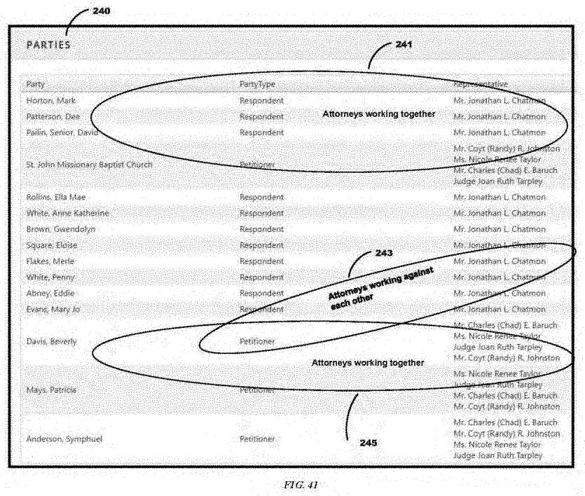

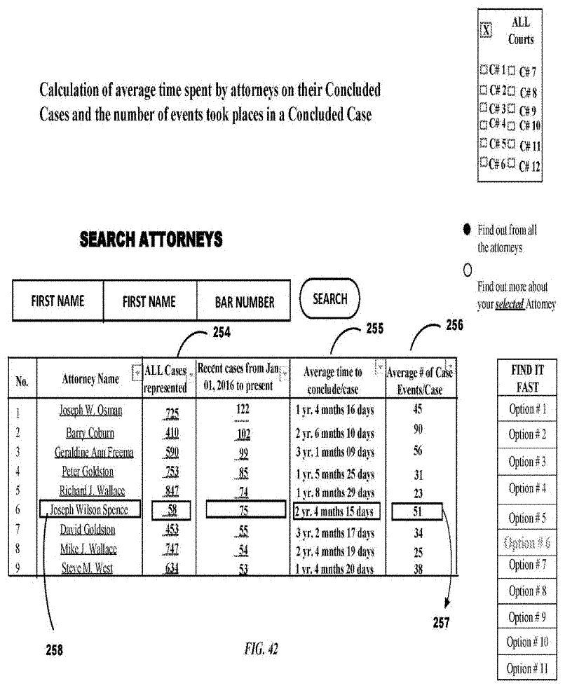

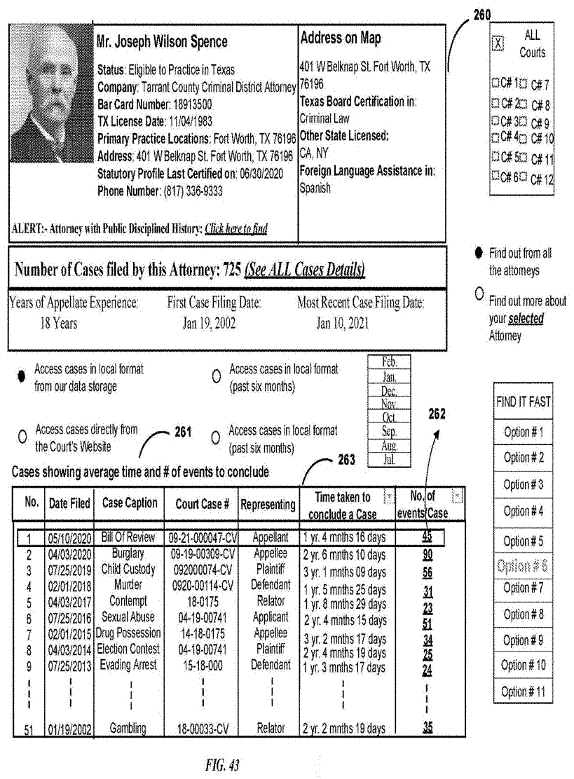

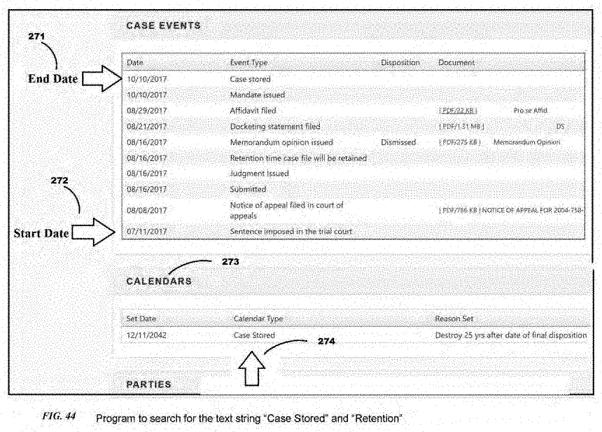

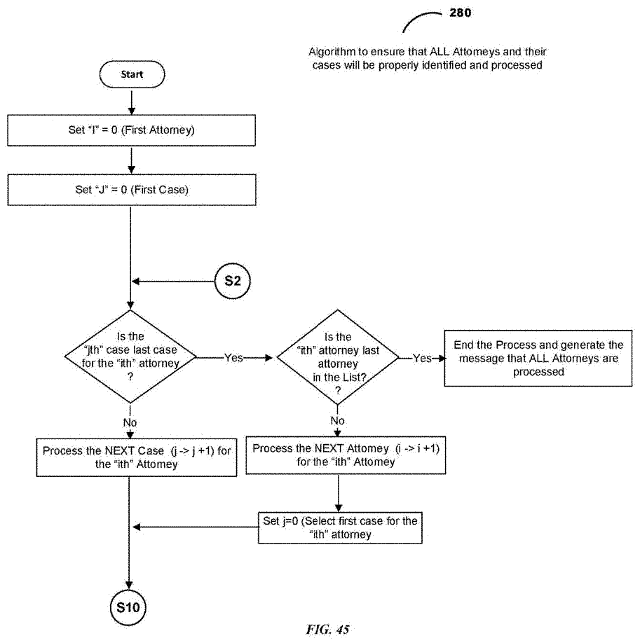

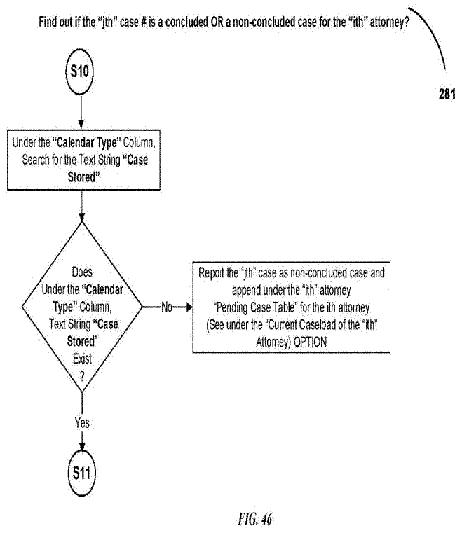

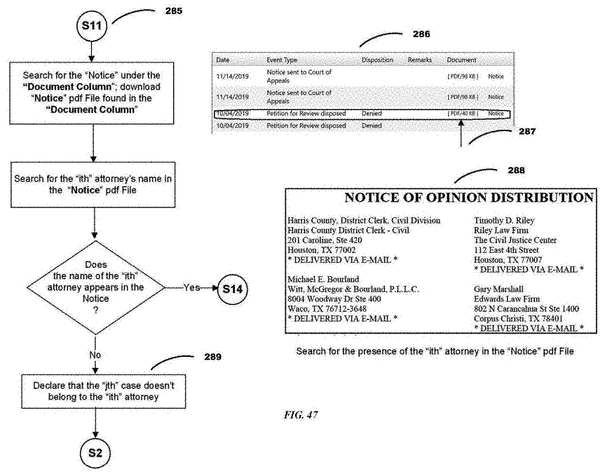

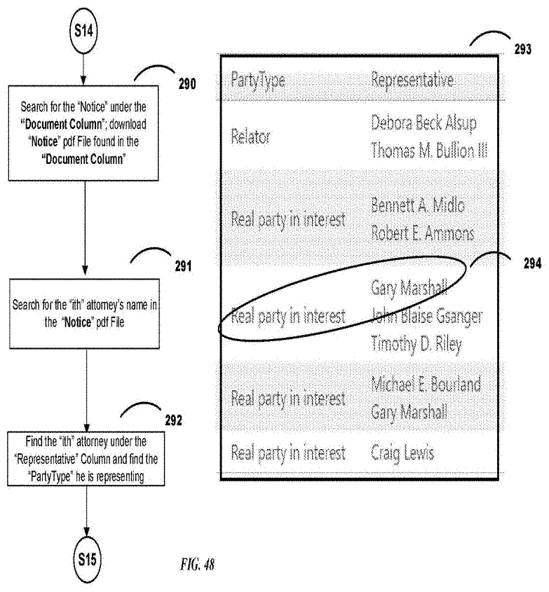

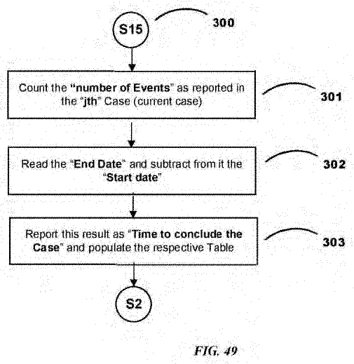

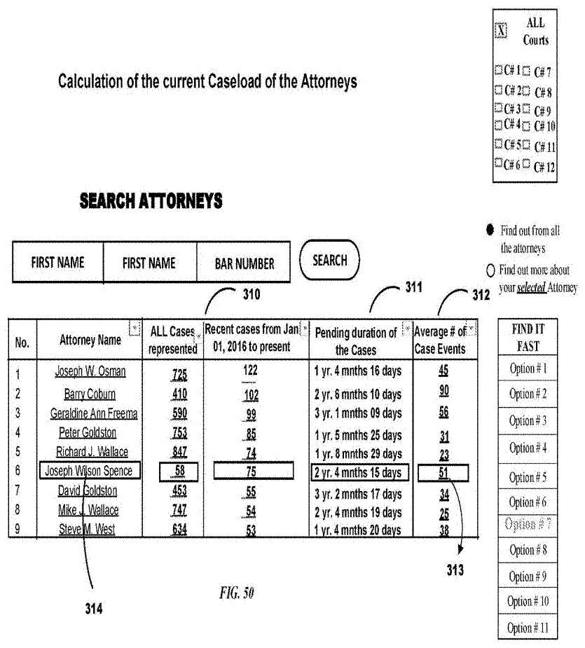

FIG. 38 illustrates a sub-routine 205 which accesses Table #2, 207, it accesses document 209. The sub-routine 205 opens the document and makes a comparison with text strings found in Table 206.

FIG. 39 illustrates a flowchart 220 which essentially makes a comparison between the name entries of attorneys to be found in the Notice 223 with the entries on the Representative Column 221. The described procedure will ensure that only attorneys who are found in both the Representative Column 221 and Notice 223 are the attorneys who are representing the case.

FIG. 40 illustrates a flowchart 230 which is used to identify the list of attorneys who have worked together or worked against each other as indicated through Representative Column 234. The result of Flowchart 230 is to identify the list of attorneys who worked together 231 and the list of attorneys who have worked against each other 232. The said result is obtained in step 233 of flowchart 230. The list of attorneys who worked together is listed in Table 235 and the list of the attorneys who worked against each other is listed in Table 237.

FIG. 41 shows the demarcation between the attorneys working together and the attorneys working against each other under the column Parties 240. The collection of attorneys under 241 and 245 indicates the group of attorneys who have worked together in one case. Similarly, the list of attorneys 243 indicates attorneys who worked against each other.

FIG. 42 shows the tabular format 254 where two separate two columns 255 and 256 display the relevant information. Column 255 shows the average amount of time spend on concluding per case whereas Column 256 shows the average number of case events per case. As an example, when a user clicks on 257, the list of all the cases represented by an attorney “Joseph Wilson Spence” 258 opens and shows all the cases he represented with the display format shown in FIG. 49.

FIG. 43 shows the details of the cases associated with an attorney 260. Table 261 further displays the individual cases represented by the said attorney. Column 263 shows the time taken to conclude a case and the next column 262 shows the number of events that occurred in this case for the conclusion of the individual case.

FIG. 44 shows a table that represents the actual case information about calculating the time spent on concluding a case. The program calculates the time spent from the first action that took place in the case “Start Date” 272 and the last action that took place “End Date” 271. The said calculation will yield the time that it took to conclude a case. The above calculation is only valid for the concluded case. Whether a case is concluded or not can be determined by checking its status under the“Calendars” Column 273. For a concluded case status, the “Calendar Type” must contain the text string which contains “case stored 274.

FIG. 45 illustrates an algorithm 280 to ensure that ALL Attorneys and their cases will be properly identified and processed.

FIG. 46 illiterates a process 281 to determine if the “jth” case # is a concluded OR a non-concluded case for the “ith” attorney?

FIG. 47 shows an algorithm 285 which determines through its last step 289 whether a “jth” case belongs to “ith” attorney or not. This determination is accomplished by looking at the Document Column 286 and then downloading one or multiple “Notices” Files 287. The said downloaded Notice Files is searched for the “ith” attorney to determine if the said “ith” attorney name is in the “Notice” File 288 or not.

FIG. 48 illustrates an algorithm expressed through a Flowchart. In step 290, the Algorithm searches for the “Notice” under the “Document Column”; it downloads the “Notice” pdf File found in the “Document Column”. In Step 291, the Algorithm searches for the “ith” attorney's name in the “Notice” pdf File. In Step 292, the Algorithm finds the “ith” attorney under the “Representative” Column and finds the “Party Type” he is representing. This is illustrated in Column 293. Under the said column, the name of the desired attorney “Gary Marshall” 294 can be found.

FIG. 49 shows an Algorithm 300 which eventually calculates the time it took to conclude a case. In Step 301, the Algorithm counts the “number of Events” as reported in the “jth” Case (current case). In Step 302, the Algorithm reads the “End Date” and subtracts from it the “Start date”. In Step 303, the Algorithm report this result as “Time to conclude the Case” and populate the respective Table.

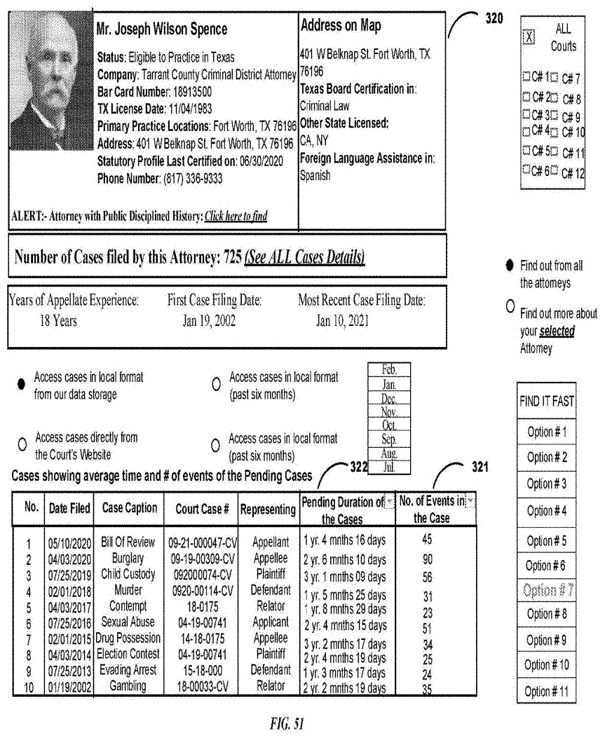

FIG. 50 shows Table 310 with Column 311 which shows the pending duration of the Cases and Column 312 which shows the average number of case events. When a user clicks on an element 313 under Column 312, all the cases belonging to the attorney “Joseph Wilson Spence” 314 will be opened.

FIG. 51 shows the profile exemplary profile of the attorney “Joseph Wilson Spence” 320. In the said profile, column 322 shows the pending duration of each case whereas column 321 reports the number of case events that occurred in each of the cases represented by the said attorney.

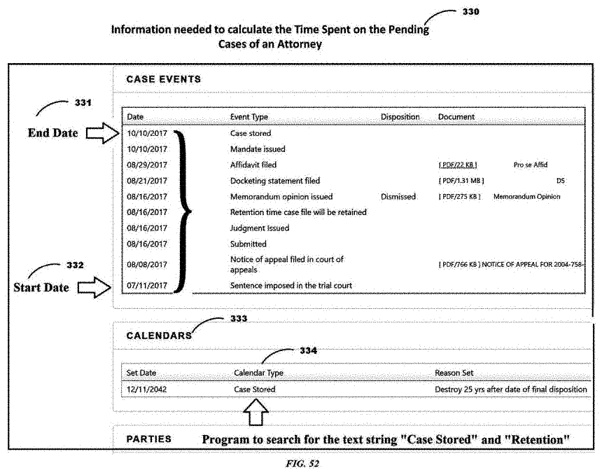

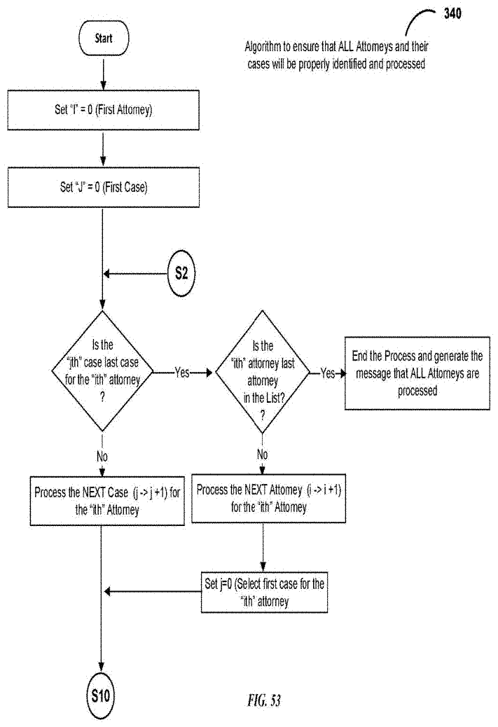

FIG. 52 shows a table that represents the actual case information about calculating the time spent on a pending case. The program calculates the time spent from the first action that took place in the case “Start Date” 332 and the last action that took place “End Date” 331. The said calculation will yield the time it is taking in the pending case. The above calculation is only valid for the pending cases. Whether a case is pending or not can be determined by checking its status under the“Calendars” Column 333. For a pending case status, the “Calendar Type” must contain the text string other than “case stored 334.

FIG. 53 illustrates an Algorithm 340 to ensure that ALL Attorneys and their cases will be properly identified and processed.

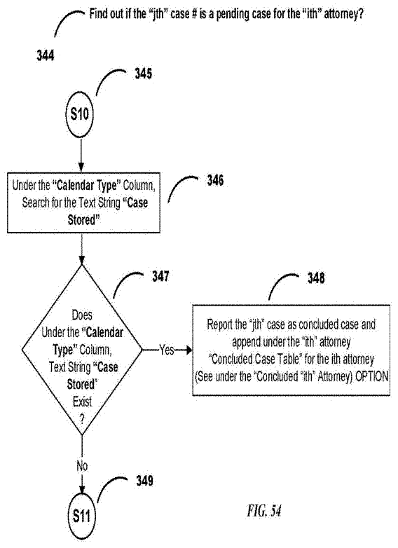

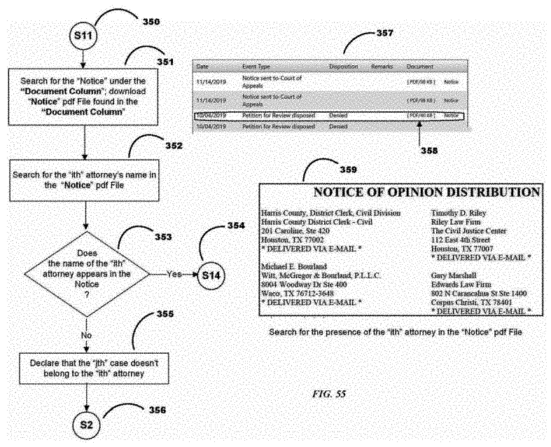

FIG. 54 details about an Algorithm 344 that can be used to determine if the “jth” case # is a pending case for the “ith” attorney. The Program starts with a sub-routine 345. In Step 346, it searches for the Text String “Case Stored” under the “Calendar Type” column. The Program checks if under the “Calendar Type” Column, Text String “Case Stored” exist. If the said, “text string” exists, then the Program branches to Step 348 where it Reports the “jth” case as concluded case and appends under the “ith” attorney “Concluded Case Table” for the ith attorney. On the other hand, the Program moves forward to another sub-routine 349.

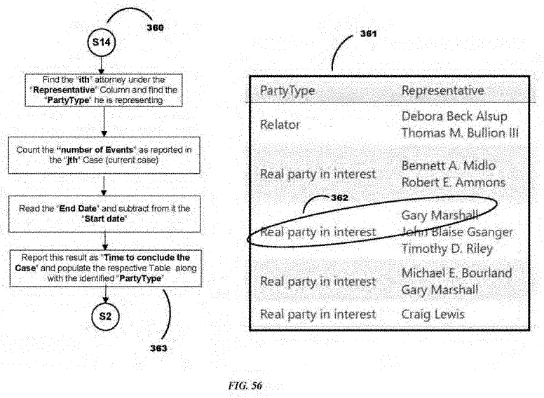

FIG. 55 shows a programming sub-routine 350. In Step 351, the Program searches for the “Notice” under the “Document Column”; it then downloads the “Notice” pdf File found in the “Document Column”. In Step 352, the Program searches for the “ith” attorney's name in the “Notice” pdf File. Step 355 is the decision box. If the condition is met, then the Program control goes to another sub-routine 354. If the condition is not met, then the Program control moves to Step 355 which declares that the “jth” case doesn't belong to the “ith” attorney. After that, the Program control moves to a different sub-routine 356. Column 357 shows a document column that the Program can download and read 358. A typical “Notice” is shown 359.

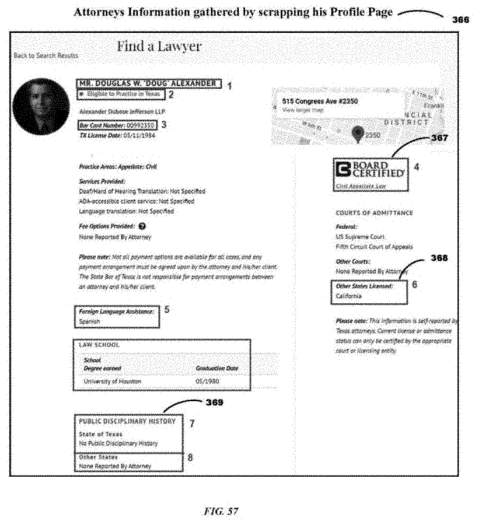

FIG. 56 shows an Algorithm 360 which is used to report the result as “Time to conclude the Case” and populate the respective Table along with the identified “Party Type”. Table 361 shows a relationship that exists between a Party Type and Representative 362. The last step 363 reports this result as “Time to conclude the Case”

FIG. 57 displays this information in Table 365. The tabular profile of an attorney can contain the name of the attorney 366. The information related to Board Certified 367 is also shown. The attorney's profile can also contain the Board's certification of the attorney. It can also state where the attorney is authorized to practice the law 368. It can also contain information related to the law school that an attorney went to 369.

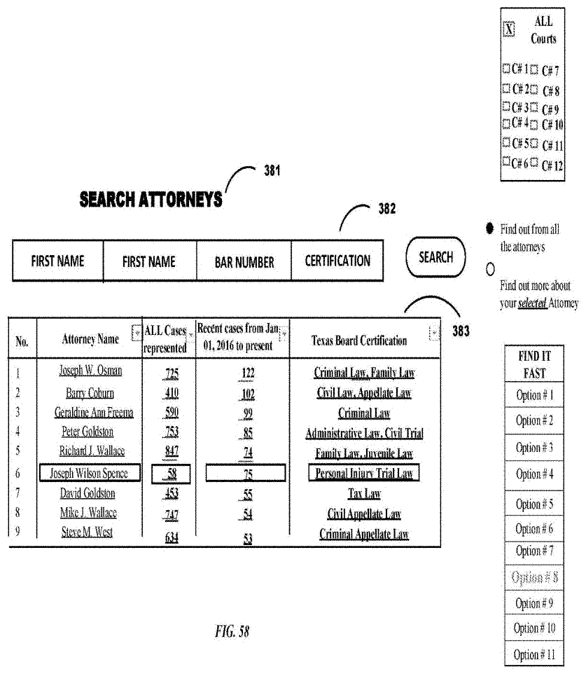

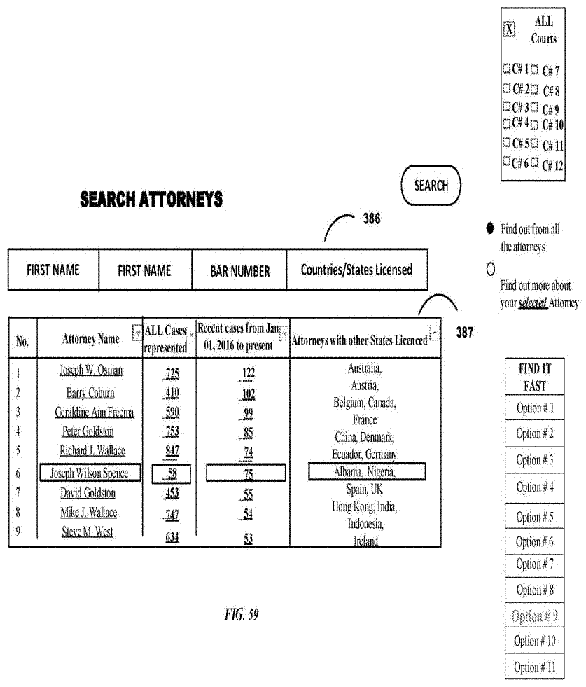

FIG. 58 shows an option 381 where a user can search and identify the type of certifications attorneys possess. A user can enter any type of certification in the search box 382. The search will return the Texas Board Certification that the attorney possesses. A user can also sort “Texas Board Certification” Column 383 to display the list of attorneys associated with these certifications.

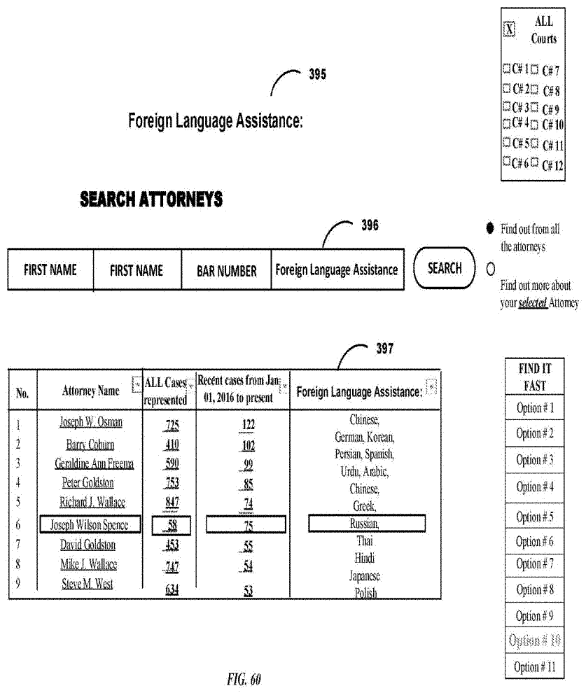

FIG. 59 presents an Option 386 where attorneys can be listed based on their countries/stated licensed certification. A user can enter any type of certification in the search box 386. The search will return the Texas Board Certification that the attorney possesses. A user can also sort “Texas Board Certification” Column 387 to display the list of attorneys associated with this field.

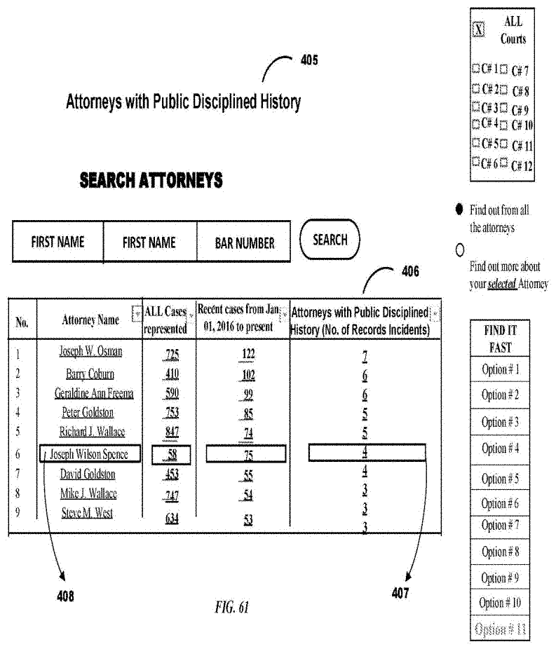

FIG. 60 shows an option for displaying Foreign Language Assistance 395, a search box 396 where a user can enter the language name to search for all attorneys who offer language assistance in that particular language. Column 397 can display one or multiple foreign languages that an attorney has the expertise and can render his services in that language.

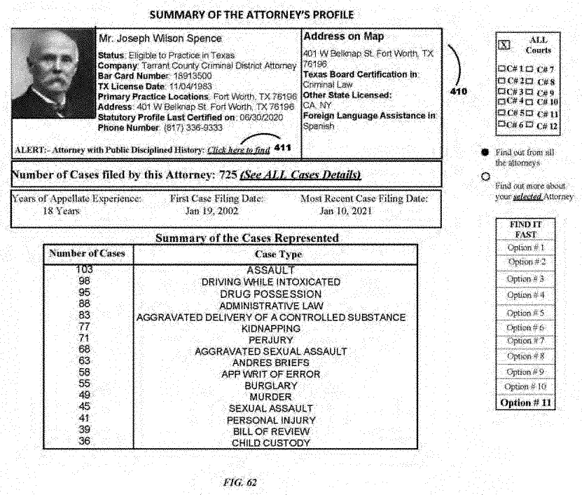

FIG. 61 shows Attorneys with Public Disciplined History 405. Column 406 shows numeric web link accessible numbers 407. This numeric number shows the number of times an attorney has been disciplined. When a user clicks on the numeric link like 407, the embedded web link under the numeric number takes the user directly to the court webpage where the user can find all the details related to the attorney's disciplinary actions. Similarly, if the user clicks on the attorney's name 408, then the summary profile of the said attorney opens.

‘FIG. 62 shows the Summary of the Attorney's Profile 410. If a user clicks on text 411, the court webpage describes all the disciplinary related actions that took place against the said attorney.

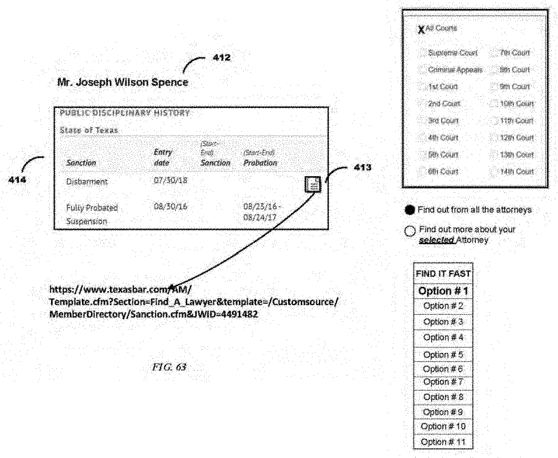

FIG. 63 shows the profile of the said attorney Joseph Wilson Spence 412. In the said profile 412 there can be one or multiple disciplinary actions, for example, 413 and 414, that took place against the said attorney. If there is an embedded document link 413 in the webpage, the said link can open a document related to the disciplinary action.

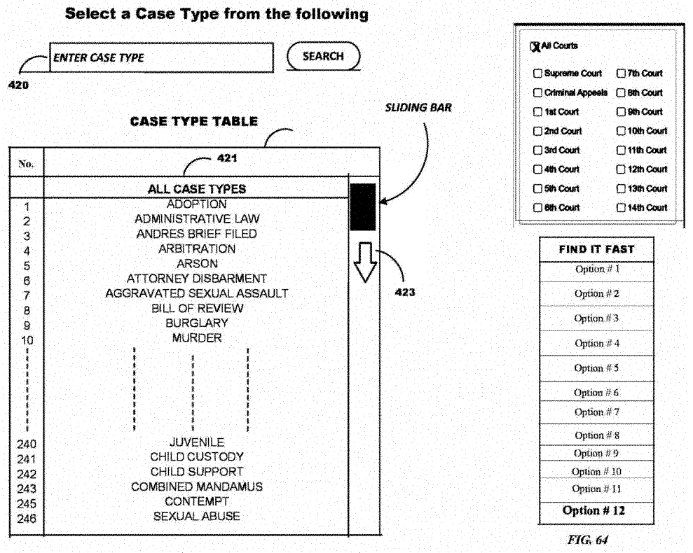

FIG. 64 shows a “Case Type Table” 421 which contains numerous types of cases. A user can also type a “case type” in the search box 420 which can select one or multiple case types by matching relevant text through the “Case Type Table” 421. A user can also scroll through different case types in Case Type Table 421 by moving scrolling bar 423 up or down.

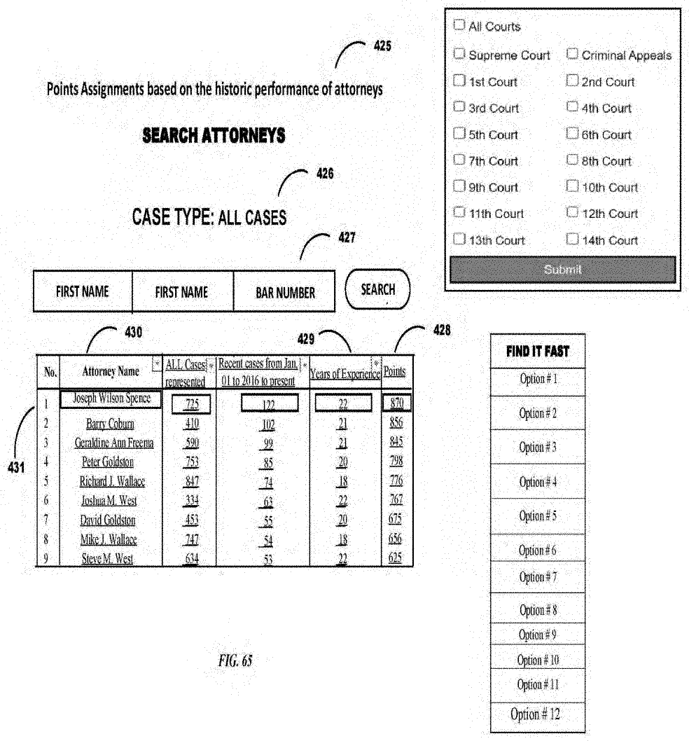

FIG. 65 describes a procedure to mathematically and statistically analyze the concept of Points Assignments 425 based on the historic performance of attorneys. A tabular display 430 of attorneys whose performance is ranked by considering the number of years of experience 429 in the appellate law and based on the points are assigned to them based on their historic performance throughout the case they represented. The assignment of numeric points is shown in column 428. A user can also search for an attorney through the search bar 427. An exemplary search result of an attorney “Joseph Wilson Spence” 431 is shown.

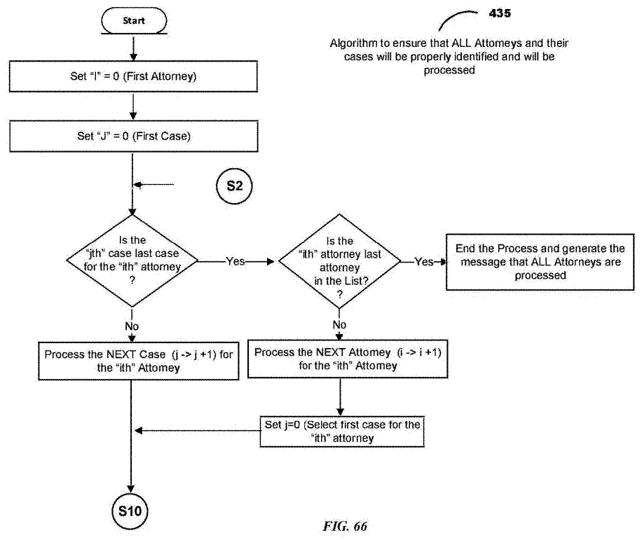

FIG. 66 illustrates an algorithm 435 to ensure that ALL Attorneys and their cases will be properly identified and processed.

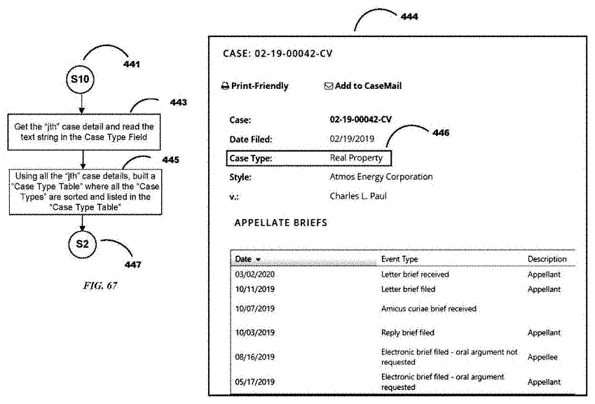

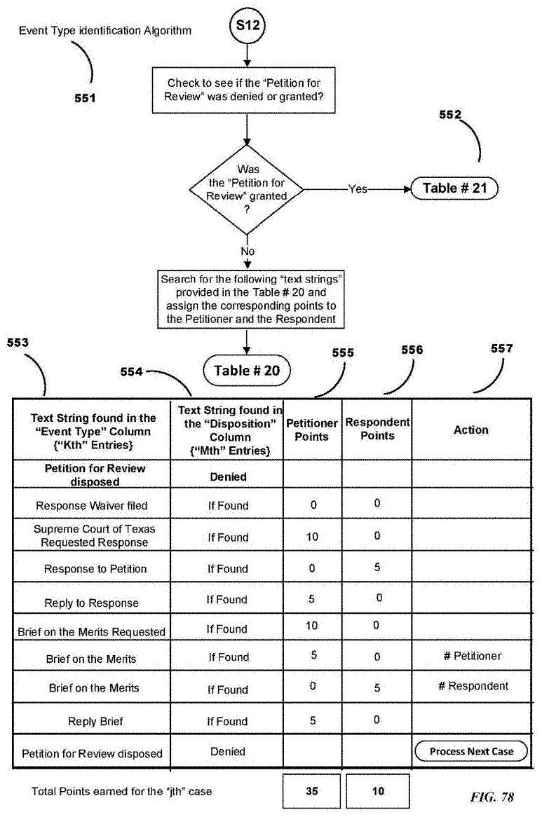

FIG. 67 shows an algorithm 440 that searches for all the cases represented by each attorney and identifies the Case Type. Step 441 kicks off the Algorithm. In Step 443 the Program gets the “jth” case detail and reads the text string in the Case Type Field. In Step 445, the Program uses all the “jth” case details, and built a “Case Type Table” where all the “Case Types” are sorted and listed in the “Case Type Table”. Step 447 processes the next case as shown through the Algorithm in FIG. 78. A case record 444 illustrates the Case Type 446 found in a case record. Report the “jth” case as a non-concluded case found.

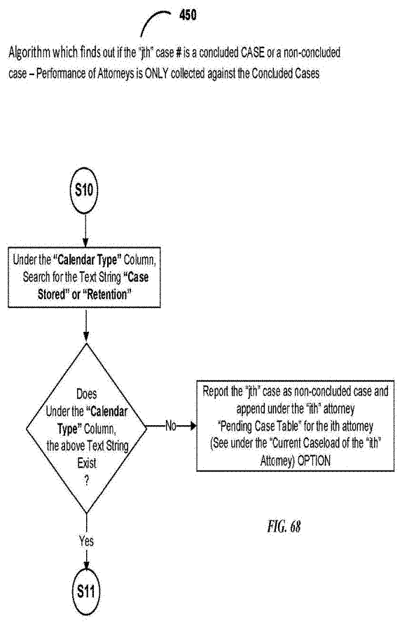

FIG. 68 describes an algorithm 450 which finds out if the “jth” case # is a concluded CASE or a non-concluded case—Performance of Attorneys is ONLY collected against the Concluded Cases.

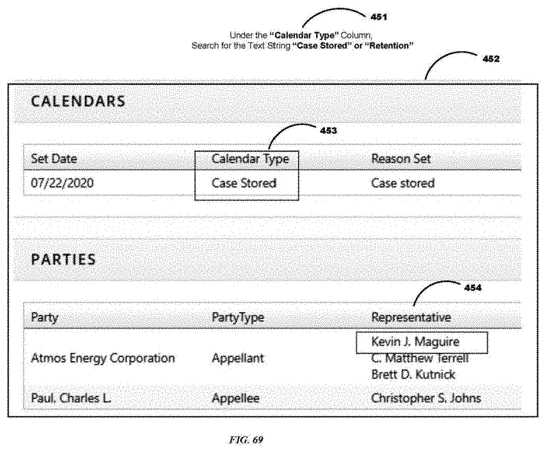

FIG. 69 shows the text string 451 that is used to conclude if the case is active or has been stored, meaning concluded. The data table 452 is used to identify through its different columns, for example, 453 to know about the status of a case which shows if a case is stored or not concluded. Under representative column 454, the attorney's name is provided.

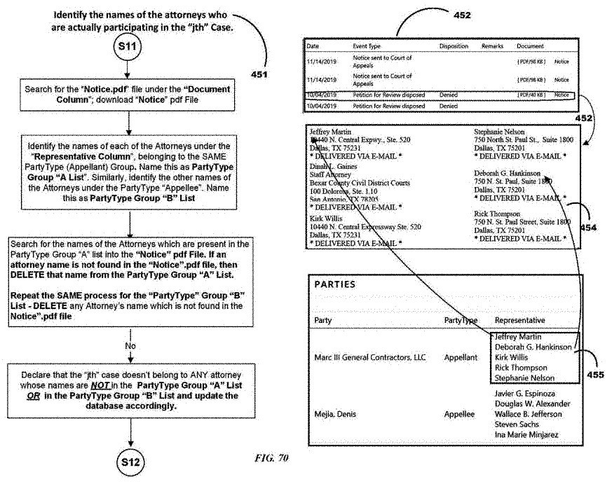

FIG. 70 illustrates an Algorithm 451 which is used to identify the names of the attorneys who are participating in the “jth” Case. It shows Table 452 which is part of the case records, and it contains Notice 453. Within the Notice, several attorneys named 454 are listed who are directly involved in the case. This is confirmed through the list of attorneys 455 which is listed under the Parties section of the case data.

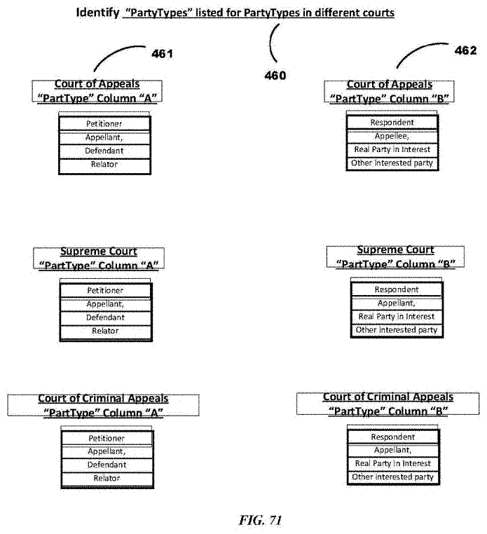

FIG. 71 shows multiple tables to identify “Party Types” 460 listed for different case types. There are different court systems and the people who represent their cases are classified differently. For example, in the court of appeals, one type of party is listed under column A 461. Whereas the other type of party is listed under Table B 462.

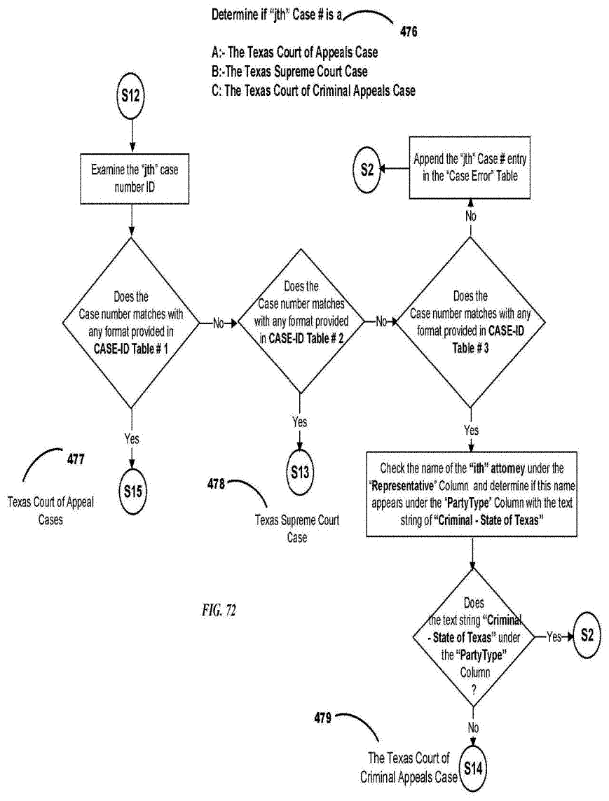

FIG. 72 shows an algorithm 476 that is used to determine a typical “jth” case classification in the Texas Court of Appeals Case, the Texas Supreme Court Case, or the Texas Court of Criminal Appeals Case. At the end of the processing, a case can belong to Texas Court of Appeal Cases 477, Texas Supreme Court Case 478, or Texas Court of Criminal Appeal Case 479.

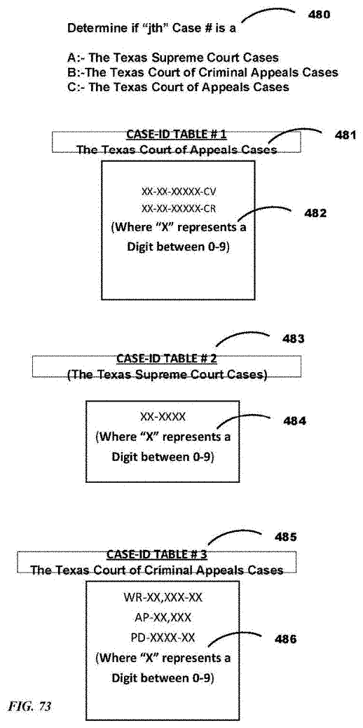

FIG. 73 shows a procedure 480 to identify the court identification by reading the case number format. This procedure enables the program to only read the case number format and identify the court where this case was deposed. The Case-ID Table 481 identifies the case if the case number format is false according to rule 482. Similarly, the Case-ID Table 483 identifies the case if the case number format is false according to rule 484. The same is true for Case-ID Table 485 which identifies the case if the case number format is false according to rule 486.

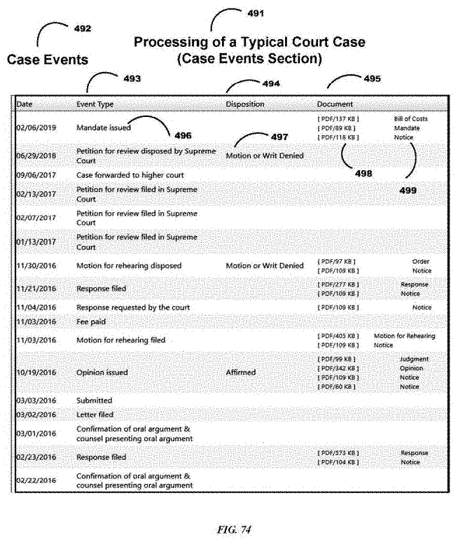

FIG. 74 shows case events in a typical case 491 which appear in the case records of a case. These case events 492 reveal how the attorneys involved in this case are making the progress. For example, under event type section 493 shows that attorneys on the case filed multiple actions and because of these actions they received different results for their clients. These results obtained by their attorneys are shown under the disposition column 494 of the Case Events Section 492. As an example, an attorney filed a motion and Event Type Column 493 shows that the motion was disposed of. The result of this motion is shown under the disposition column 494. The document containing the result “Granted” 497 of the Disposition is also attached via a downloadable web link 498. The classification of Order 499 is also reported.

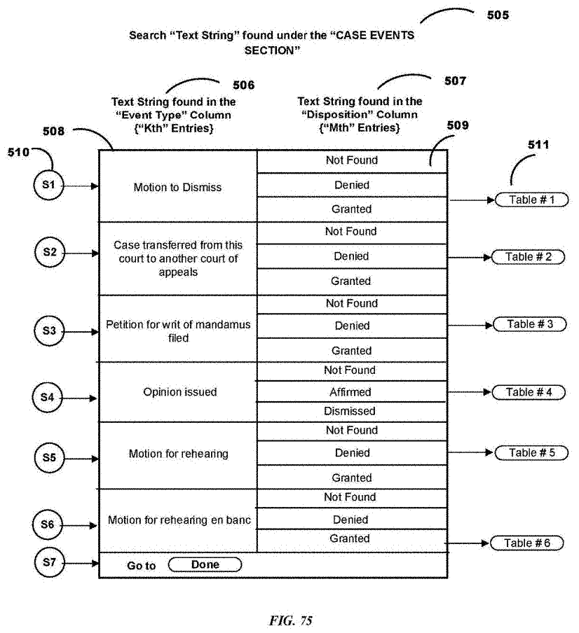

FIG. 75 shows a procedure for identifying and searching a “Text String” to be found under the “Case Events Section” of a case. The process shows an algorithm that operates by reading the text string found under the Event Type Section specifically under the two columns, under the Event Type text description 506 and the Disposition Column text string 507. The “kth” and “mth” entries define variables that are incremented by the pogrom to advance to different rows in both Event Type Column 506 and Disposition Column 507, respectively. The multiple states, like 510, represent an entry point to the Table and analyze which text strings are matched. Based on the text string findings the results are compared with the different text string values in the Disposition Column 507. The results in the said column 509 are fed to different Tables, for example, Table #1, 511. Similarly, different text string values found in the Event Type Columns lead to different tables. The results concluded through the processing of Tables are fed back to different states, for example, 510.

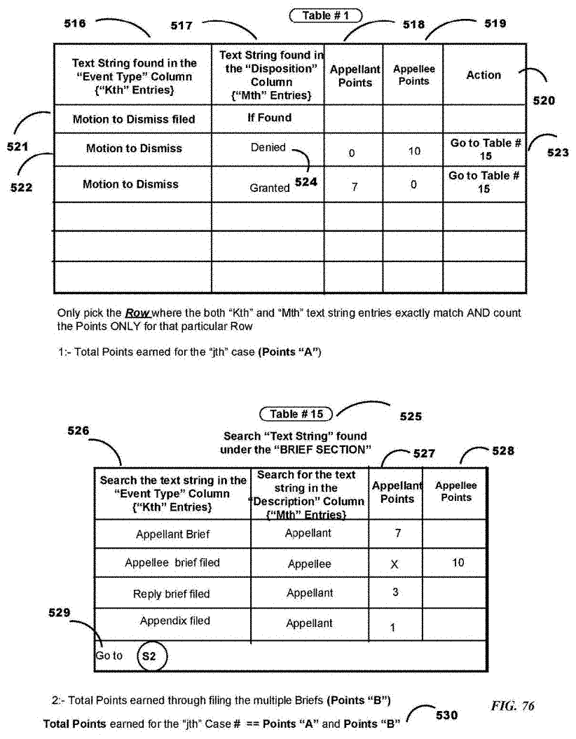

FIG. 76 shows the flow of the program based on the value of the text strings it reads from the row entries listed in the “Event Type” Column 516. As an example, if a Motion to dismiss is filed 521, then the program will read the text string entries in the Disposition Column 517 and will read the outcome of the Motion to Dismiss under the Disposition Column 517. If the text string value read from the jth column in the case deposition column 517 is “Denied” 524 then the Program will assign a certain number of points for both Appellant and Appellee under their respective columns 518 and 519. After assigning the points the program will read the corresponding instruction 523 provided under the Action column 520. In this example, the program will read instruction 523 and will go to Table #15. Table #15, 525 specifically read the entries of the “Appellate Briefs” Section. The Program reads the Event Type Column 526 and determines which types of Appellate Briefs are filed by the Appellant and Appellee. Based on the type of the Brief filed certain points are assigned as Appellant's Points 527 or Appellee's Points 528. After that, the program control is passed which takes it back to 529. The total points 530 assigned for the appellant's or the appellee's attorneys for the current case “jth” can be the sum of Points “A” and Point “B”.

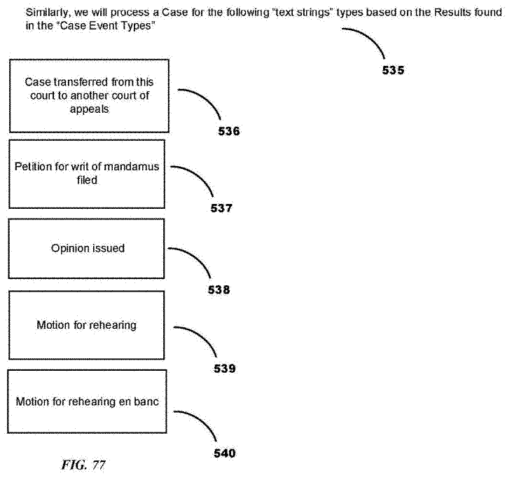

FIG. 77 shows the processing 535 of “text strings” types based on the Results found in the “Case Event Types”. A typical list of “Case Event Types” includes Case transferred from this court to another court of appeals 536, Petition for writ of mandamus filed 537, Opinion issued 538, Motion for rehearing 539, and Motion for rehearing en banc 540. There can be other case event types and based on these even types a point-based system can be assigned for the attorneys who participated in these case events.

FIG. 78 illustrates the processing of an Event Type identification Algorithm 551. The result obtained through this process can be fed to different Tables, for example, Table #20, after meeting the defined criteria. Column 553 consists of multiple rows. Each row entry under the said column 553 is sequentially checked. Based on the matched text string values a certain number of points are assigned under the Petitioner Points Column 555 and Respondent Points Column 556. Based on the results produced the program will take certain actions as listed under the “Action” Column 557

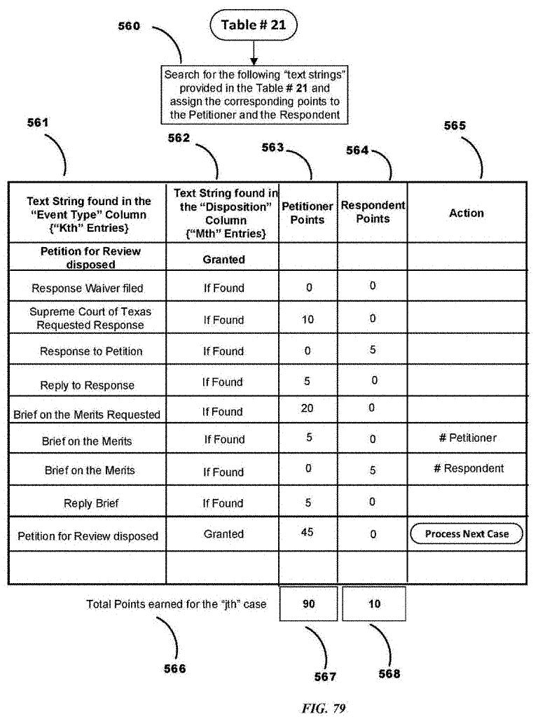

FIG. 79 directs the Program to search for a list of “text strings” provided in Table #21 and assign the corresponding points to the Petitioner and the Respondent listed under column 563 and column 564, respectively. A list of text strings under the Event Type Column 561 is read in the “jth” case entries to determine which text entries are found in the actual case. If a certain set of text entries are found in the “Event Type” column of the “jth” case “then the corresponding “Disposition Colum” 562 checks the status of either being present or missing. Based on its status, it would assign a certain point for the Petitioner and Respondent from columns 563 and 564, respectively. Any actions that need to be taken based on the results are listed under column 565. The total points earned 566 by either the Petitioner or Respondent are listed under the reporting boxes 567 and 568, respectively.

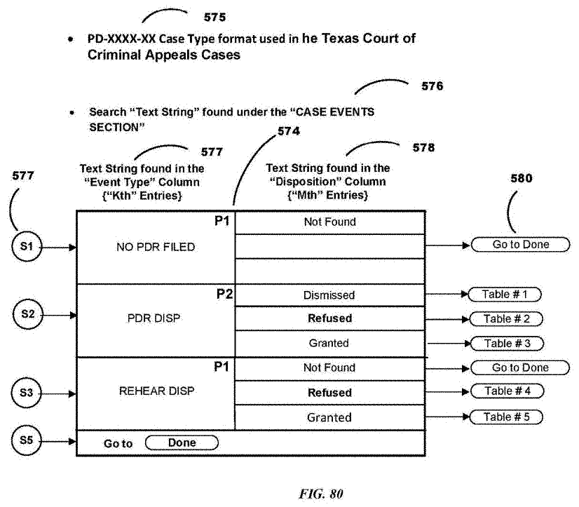

FIG. 80 shows a specific case format, for example, 575 for the “PD-XXXX-XX” Case Type format used in the Texas Court of Criminal Appeals Cases. The program specifically executes the search “Text String” found under the “CASE EVENTS SECTION” 576. Table 574 is shown with two columns 577 which represents Text String found in the “Event Type” Column and column 578 which represents Text String found in the “Disposition” Column 578. Based on the results found in the Disposition Column 578, the program's control can be directed to another subroutine 580, as an example.

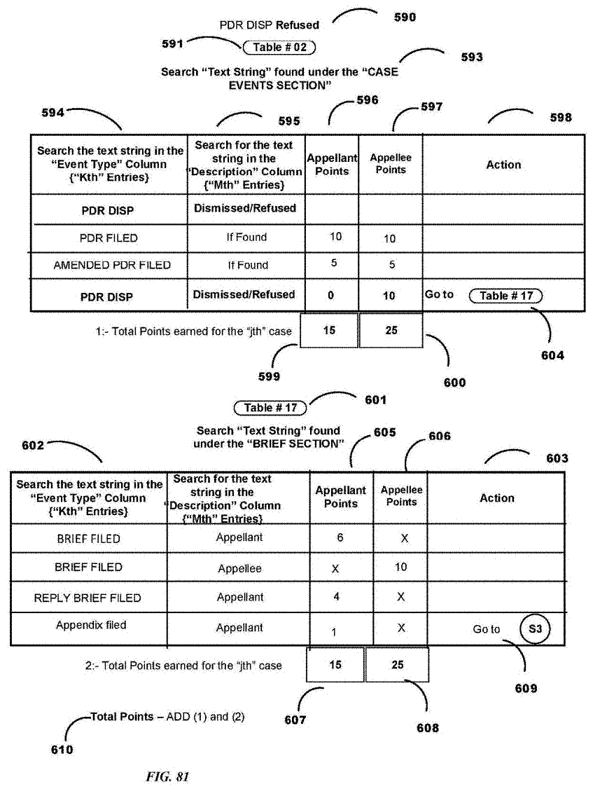

FIG. 81 shows the disposition case category as an example, “PDR DISP Refused” 590. The processing of this exemplary case category “PDR DISP Refused 590 is processed at Table #02, 591 is the flow of the program based on the value of the text strings 593. The program reads row entries listed in the “Event Type” Column 594. As an example, if “PDR DISP” is filed under the column 594, then the program will read the text string entries in the Disposition Column 595 and will read the outcome of the “PDR DISP”. If the text string value read from the column 595 is “Dismissed/Refused” then Program will assign the certain number of points for both Appellant and Appellee under their respective columns 596 and 597. After assigning the points the Program will read the corresponding instruction provided under the Action column 598. In this example, the Program will read the instruction 604 and will go to Table #17, 601 Table #17, 601 specifically read the entries of the “Appellate Briefs” Section. The Program reads the Event Type Column 602 and determines which types of Appellate Briefs are filed by the Appellant and Appellee. Based on the type of the Brief filed certain points are assigned as Appellant's Points 605 or Appellee's Points 606. After that, the program control is passed which takes it back to 609. The total points 607 assigned for the appellants or the appellee's attorneys 608 are reported. The total points accumulated by the Appellant's attorney or Appellee's attorney for the current case “jth” can be the sum of Points under Section #1 and Section #2, 610.

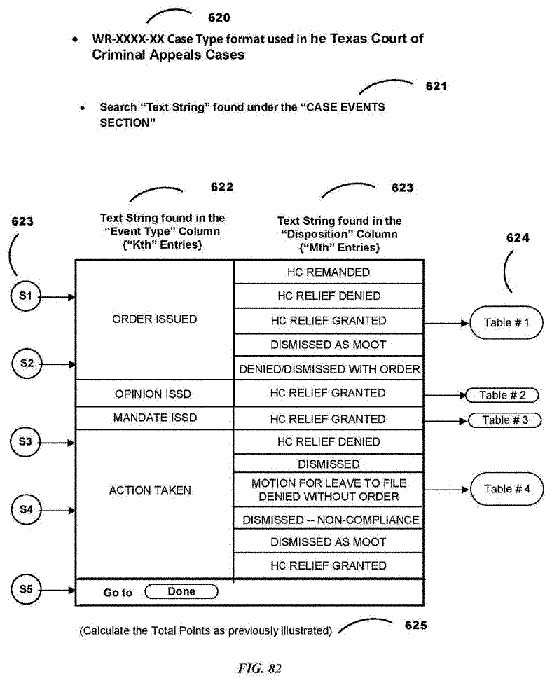

FIG. 82 shows a specific case format, for example, 620 for the “WR-XXXX-XX” Case Type format used in the Texas Court of Criminal Appeals Cases. The program specifically executes the search “Text String” 621 found under the “CASE EVENTS SECTION” 622. A Table is shown with two columns 622 which represents the Text String found in the “Event Type” Column and column 623 which represents the Text String found in the “Disposition” Column. Based on text string as found in the Disposition Column 623, the Program can branch to different Tables, as an example, “Table #1” 624. The total points as accumulated by Attorneys representing diverse parties can be calculated at 625.

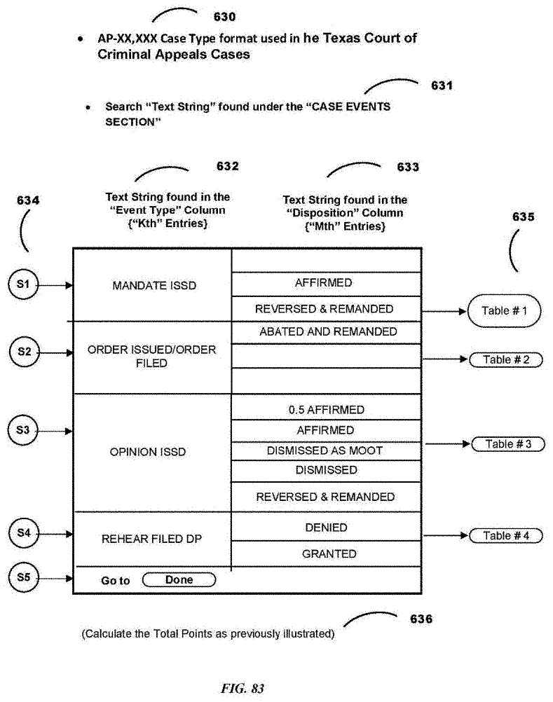

FIG. 83 shows a specific case format, for example, 630 for the “AP-XX, XXX” Case Type format used in the Texas Court of Criminal Appeals Cases. The program specifically executes the search “Text String” 631 found under the “CASE EVENTS SECTION” 631. A Table is shown with two columns 632 which represents the Text String found in the “Event Type” Column and column 633 which represents the Text String found in the “Disposition” Column. Based on text string as found in the Disposition Column 633, the Program can branch to different Tables, as an example, “Table #1” 635. The total points as accumulated by Attorneys representing diverse parties can be calculated. Similarly, based on the results obtained through processing Table #1 635, the program can branch the control back to any of the states 634. The total points as accumulated by Attorneys representing diverse parties can be calculated at 636.

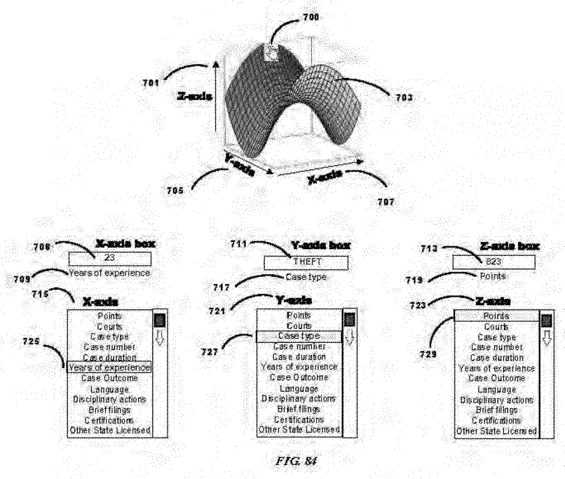

FIG. 84 illustrates another method of displaying results through 3-D chart drawings. A graphical display system 700 is used to draw 3-D graphs. The said system 700 utilizes X-axis 707, Y-axis 705, and Z-axis 701 to draw a 3-D graph. As an example, a 3-D graph 703 can be drawn using the above-referenced axis. Each axis can be independently and simultaneously controlled by writing in X-axis box 708, Y-axis box 711, and Z-axis box 713. As an example, a user can pick an item from a drop-down menu 725 “Years of experience” which will appear as “Years of experience” 709. Similarly, the said user can independently select the Y-axis drop-down menu 721 and can select an item Case Type 727. In the Y-axis box, he can select “Theft” 711 as a “Case Type”. For a Z-axis box, the said user can select an item “Points” 729 from the drop menu 723. For the value of the “Points” 719, the user can insert a numeric value, for example, 823, in the Z-axis box 713. Once all the 3-D values are provided to the Program, it can draw a 3-D graph 703711, and Z-axis box 713. As an example, a user can pick an item from a drop-down menu 725 “Years of experience” which will appear as “Years of experience” 709.

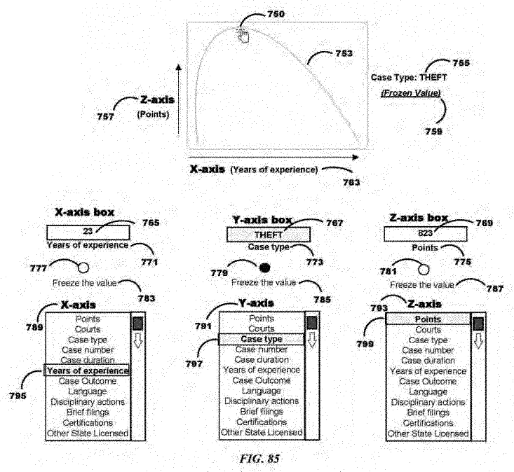

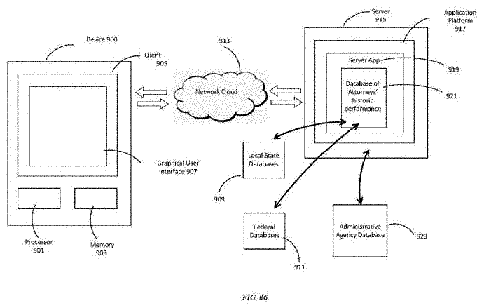

FIG. 85 illustrates another method of displaying results through 2-D chart drawings. In this method, one axis out of the three-axis (X-axis, Y-axis, and Z-axis), one axis can be kept “frozen”, meaning its value can be fixed and the variable values fed to the remaining two axes are used to draw 2-D graphical charts. As an example, any selected items present in the Y-Axis 791 can be kept frozen by activating the radio button 779. This leaves the user to select different times in the drop-down menu X-axis 789 and Z-axis 793 while picking a pre-determined value of the item in the said menu 791 and keeping it fixed through 779. A graphical display system 753 is used to draw 2-D graphs 753. The processor utilizes X-axis 763 and Z-axis 757 to draw a 2-D graph. As an example, a 2-D graph 753 can be drawn using the above-referenced axis. Each axis can be independently and simultaneously controlled by writing in X-axis box 765, and Z-axis box 769. As an example, a user can pick an item from a drop down menu 789 “Years of experience” 795. Similarly, the said user can independently select Y-axis to drop down menu 791 and can select an item “Case Type” 797, and can freeze the said selection by selecting the radio button 779. In the Y-axis box, the said user can select “Theft” 767 as a “Case Type” 773. For a Z-axis box, the said user can select an item “Points” 775 and its numeric value 769 from the drop menu 793. The position location of the Case Type “Points” is indicated through 799. Once all these 2-D values are provided to the Program, it can draw a 2-D graph 753. A user can move the mouse cursor 750 across the path of the graphical curve 753 and the corresponding X-axis 763 values will be updated in the X-axis box 765 and similarly, Z-axis 757 will be updated in the Z-axis box 769

In an exemplary embodiment, a device 900 is equipped with a processor 901 and a memory 903. There can be client 905 installed in the said device 900. An exemplary client 905 can be a browser or ftp or a software that can display results and can manage an Internet communication. The said Internet communication can be managed through the network cloud 913. The receiving end of the communication can be a server 915 which has an application platform 917. It can have a server app 919 which can have a database of attorneys' historic performance 921. The said database server is connected to local state database 909, federal database 911, and administrative agency database 923. The user may be asked a series of questions to answer via a survey or other instruments to determine the best fit attorney. In the instance of asking user questions, the questions may be in the form of hypotheticals, analogies, or real world examples, and may be asked directly or indirectly with respect to the attorney ranking operations in order to extract data from the state databases 909, Federal databases 911, and administrative agency databases 923. As such, the questions associated with the historic data collected about attorneys include a significant number of possibilities but are reduced based on history and prior feedback. In addition, machine learning and artificial intelligence applications may be employed to search remote databases, identify patterns and model data sets in attempts to augment data derived from the sets of questions and input activities

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

Techniques and technologies may be described herein in terms of functional and/or logical block components, and with a reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIGS. depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for generating data for evaluating the legal experience of legal personnel, the method comprising:
populating a user interface with data about past case history of at least one legal individual for enabling a user to determine whether or not to make a selection decision about the at least one legal individual; and
in response to a user selection, enabling one or more different options for displaying the case history of the at least one legal individual for user selection;
wherein the user interface is configured to display a listing of legal personnel and associated one or more representative matters;
wherein the user interface is configured to display an event, disposition, and attachment associated with the one or more representative matters;
wherein the user interface displays a score associated with the legal personnel that is calculated based on a plurality of attributes comprising representative cases, recent representative matters, and years of experience; and
wherein the score is calculated using an intelligent model that compares a set of legal personnel that is selected by the user using selection options available in the user interface.

2. The method of claim 1, further comprising:
wherein the user interface displays a pre-set set of options for user selection to enable the user to determine one or more categories of information about the legal individual by a one-click action.

3. The method of claim 2, further comprising
wherein the intelligent model associates one or more legal individuals that are conflicted or not in conflict with respect to one or more representative matters that are displayed in the user interface.

4. The method of claim 3, further comprising:
wherein the intelligent model searches one or more notices of distribution for the legal individual associated with one or more representative matters to display relevant information in one or more fields in the user interface to the user to enable the user selection of at least one legal individual.

5. The method of claim 4, further comprising:
wherein the relevant information in the one or more fields comprises: event type, disposition, and party names.

6. The method of claim 3, further comprising:
wherein the event type comprises at least a type of motion, brief, or notice of a late filing.

7. The method of claim 6, further comprising:
wherein the intelligent model is configured to determine whether or not a case is stored based on searching data associated with a representative matter and a case stored or retention field in a calendar associated with a party or representative of the representative matter.

8. The method of claim 7, further comprising:
wherein the intelligent model is configured to determine based on the calendar whether the case is stored as an active case in a appellant case or if the case is a non-active case as the appellant case.

9. The method of claim 8, further comprising:
wherein the intelligent model is configured to determine based on a number of active cases or non-active cases a particular legal individual is handling and estimate an amount of available time the legal personnel spends on a new case.

10. The method of claim 9, further comprising:
wherein the intelligent model is configured to determine the number of days to a resolution of a representative matter and a disposition of the representative matter.

11. The method of claim 10, further comprising:
wherein the intelligent model is configured to determine monies related to a number of days to the resolution of a representative matter and a disposition of the representative matter.

12. The method of claim 11, further comprising:
wherein the intelligent model is configured to present a set of options for selection by the user that includes an option comprising a public disciplinary history of the legal personnel.

13. The method of claim 12, further comprising:
wherein upon selection of the option for the public disciplinary history of the legal personnel, a listing is presented in the user interface of one or more actions related to legal discipline of the legal personnel.

14. A method for navigating data related to a legal professional, the method comprising:
displaying a graph with multiple axes mapped to a set of fields comprising experience data, case data, and evaluation score; and
enabling a user to select an item associated with one or more axes in a dropdown menu and mapping a point position on the graph that is associated with the item selection.

15. The method of claim 14, further comprising:
wherein the graph is a two-dimensional graph that maps in accordance with at least one item selection by the user, a set comprising attributes of the legal professional comprising at least experience and representative matter to an evaluation score displayed on the two-dimensional graph.

16. The method of claim 15, further comprising:
wherein the graph is a three-dimensional graph that maps in accordance with at least one item selection by the user, a set comprising attributes of the legal professional comprising at least experience, representative matter, and an evaluation score displayed on the three-dimensional graph.

17. A system for generating data for evaluating legal experience of legal personnel, the system comprising:
a processor configured to populate a user interface with data about past case history of at least one legal personnel for enabling a user to determine whether or not to make a selection decision about the at least one legal personnel; and
in response to a user selection, a processor is configured to display one or more different options in the user interface of a case history of the at least one legal personnel for user selection;
wherein the user interface is configured to display a listing of legal personnel and associated one or more representative matters;
wherein the user interface is configured to display an event, disposition, and attachment associated with the one or more representative matters;
wherein the user interface displays a score associated with the legal personnel that is calculated based on a plurality of attributes comprising representative cases, recent representative matters, and years of experience; and
wherein the score is calculated by the processor using an intelligent model that compares a set of legal personnel that is selected by the user using selection options available in the user interface.

18. The system of claim 17, further comprising:
wherein the user interface displays a pre-set set of options for user selection to enable the user to determine one or more categories of information about the legal personnel by a one-click action.

19. The system of claim 18, further comprising
wherein the intelligent model associates one or more legal personnel that are conflicted or not in conflict with respect to one or more representative matters that are displayed in the user interface.

20. The system of claim 19, further comprising:
wherein the intelligent model is configured to determine whether or not the person is an actual trial individual or is an appellate level individual.
